(19) United States
(12) Patent Application Publication
(10) Pub. No.: US 2026/0149160 A1
(43) Pub. Date: May 28, 2026

(54) MONOLITHIC INTERPOSER HAVING A LOW-LOSS THZ WAVEGUIDE

(71) Applicant: Attotude, Inc., Menlo Park, CA (US)

(72) Inventors: Phill Amaya, San Jose, CA (US); Alexandria Welch, Atherton, CA (US); Philip Kness, Boise, ID (US); Peter Apostolakis, Mountain View, CA (US); David F. Welch, Atherton, CA (US); Joy Laskar, Mountain View, CA (US)

(21) Appl. No.: 19/397,267

(22) Filed: Nov. 21, 2025

Related U.S. Application Data
(60) Provisional application No. 63/723,941, filed on Nov. 22, 2024.

(51) Int. Cl. H01P 5/12; H01P 3/02; H01P 3/16; H04B 10/90

(52) U.S. Cl. CPC H01P 5/12; H01P 3/026; H01P 3/16; H04B 10/90; H04B 2210/006

(57) ABSTRACT

Systems and methods include a Terahertz (THz) interposer assembly comprising a THz interposer and a plurality of THz waveguides. The THz interposer defines a plurality of first ports and a plurality of second ports. Each of the plurality of THz waveguides is disposed within the THz interposer. Each of the plurality of THz waveguides extends between a respective one of the plurality of first ports and a respective one of the plurality of second ports. Each of the plurality of THz waveguides is configured to propagate, between the respective one of the plurality of first ports and the respective one of the plurality of second ports, one or more THz signals having a frequency in a range between 300 Gigahertz (GHz) and 10 THz with a propagation loss in a range between 0.001 decibels (dB) per centimeter (cm) and 1.0 dB per cm.

### CROSS-REFERENCE TO RELATED APPLICATION

The present patent application claims priority to the United States provisional application identified by U.S. Ser. No. 63/723,941, filed on Nov. 22, 2024, the entire content of which is hereby incorporated herein by reference.

### BACKGROUND

Optical networking is a means of communication that uses signals encoded in light to transmit information in various types of telecommunications networks, including limited range local-area networks (LANs) or wide-area networks (WANs). It is a form of optical communication that relies on optical amplifiers, lasers, or LEDs and wavelength-division multiplexing (WDM) to transmit large quantities of data, generally across fiber-optic cables. Because it is capable of achieving extremely high bandwidth, it is an enabling technology for the Internet and telecommunication networks that transmit the vast majority of all human and machine-to-machine information. However, further development and optimization of optical networking systems faces certain limiting factors, namely, power dissipation, thermal requirements, and mechanical tolerances.

Optical components generate photons by exciting electrons in a gain medium, and the electrons emit photons as they return to lower energy levels. Despite efforts to improve efficiency, optical components generate some amount of heat during the electron excitation process, and such heat is referred to as power dissipation. Excessive power dissipation may lead to thermal management problems and may affect the performance and longevity of the optical components.

Optical components are sensitive to temperature fluctuations and often require lower operating temperatures than purely electronic components to maintain optimal performance. Elevated temperatures may result in increased signal noise, diminished signal quality, and reduced service life for optical components. Accordingly, optical components often require cooling systems (e.g., heat sinks, fans, or thermoelectric devices) to dissipate excess heat and maintain the optical components within a safe temperature range.

Optical networking systems typically operate in micrometer wavelengths, demanding extreme precision in component fabrication, assembly, and alignment. Even slight deviations from the required mechanical tolerances may lead to signal degradation, loss, or the introduction of optical crosstalk, negatively impacting network performance. Achieving and maintaining the necessary mechanical tolerances necessitates advanced manufacturing techniques and stringent quality control measures.

Terahertz (THz) wireless communications in a frequency range between 300 Gigahertz (GHz) and 10 THz offer the potential for extremely high data rates, but face significant technical challenges. Existing approaches for transmitting and receiving dual-polarized THz signals have relied heavily on optical components, increasing complexity, cost, and power consumption.

### SUMMARY

Thus, a need exists for a landing connector and/or monolithic interposer to couple a radiated electromagnetic wave having input data encoded into a carrier frequency within a range between 300 GHz and 10 THz into or out of an integrated circuit. It is to such a landing connector and/or monolithic interposer that the present disclosure is directed.

In a first aspect, the present disclosure includes a landing connector. The landing connector comprises a first waveguide, a second waveguide, and a reflector. The first waveguide is configured to receive at least a portion of an antenna. The second waveguide intersects the first waveguide at an intersection. And, the reflector is positioned at the intersection and is configured to reflect an electromagnetic wave having data encoded within a carrier frequency in a range between 300 GHz and 10 THz.

In a second aspect, the present disclosure includes a second landing connector. The second landing connector comprises a first waveguide configured to couple to a substrate integrated waveguide; a second waveguide intersecting the first waveguide at an intersection; and a reflector positioned at the intersection and configured to direct an electromagnetic wave having data encoded within a carrier frequency in a range between 300 GHz and 10 THz from the first waveguide to the second waveguide.

In a third aspect, the present disclosure includes a third landing connector. The third landing connector comprises a series of exposed contacts, a coupler, a first waveguide, and a second waveguide. The series of exposed contacts are configured to connect to an integrated circuit or distribution board. The coupler is operable to launch a radiated electromagnetic wave having data encoded within a carrier frequency in a range between 300 GHz and 10 THz based on energy received from the series of exposed contacts. The first waveguide is configured to accept the radiated electromagnetic wave from the coupler. And, the second waveguide intersects the first waveguide at an intersection to accept the radiated electromagnetic wave from the first waveguide.

In a fourth aspect, the present disclosure includes a fourth landing connector. The fourth landing connector comprises a landing body and a waveguide formed in the landing body. The waveguide has an interior surface formed by a conductive material, a first opening having a first cross-sectional dimension, and a second opening disposed opposite the first opening and having a second cross-sectional dimension greater than the first cross-sectional dimension. The first cross-sectional dimension is configured to receive at least a portion of an antenna. The waveguide is configured to guide an electromagnetic wave having data encoded within a carrier frequency in a range between 300 GHz and 10 THz.

In a fifth aspect, the present disclosure includes a radio frequency guide. The radio frequency guide comprises a first horn, a second horn, a first THz waveguide, and a second THz waveguide. The first horn has a first end, a second end, and a first sidewall extending from the first end to the second end. The first sidewall surrounds a first opening extending from the first end to the second end. The first opening has a first input and a first output with the first opening tapering upwardly toward the first output. The second horn has a third end, a fourth end, and a second sidewall extending from the third end to the fourth end. The second sidewall surrounds a second opening extending from the third end to the fourth end. The second opening has a second input and a second output with the second opening tapering upwardly toward the second output. The first THz waveguide extends from the first output of the first opening to the second input of the second opening. The second THz waveguide extends from the second output.

In a sixth aspect, the present disclosure includes a THz interposer assembly, comprising: a THz interposer defining a plurality of first ports and a plurality of second ports; and a plurality of THz waveguides disposed within the THz interposer, wherein each of the plurality of THz waveguides extends between a respective one of the plurality of first ports and a respective one of the plurality of second ports, and is configured to propagate, between the respective one of the plurality of first ports and the respective one of the plurality of second ports, one or more THz signals having a frequency in a range between 300 Gigahertz (GHz) and 10 THz with a propagation loss in a range between 0.001 decibels (dB) per centimeter (cm) and 1.0 dB per cm.

In a seventh aspect, the present disclosure includes a Terahertz (THz) transmission system, comprising: one or more THz transceivers, each of one or more THz transceivers comprising one or more signal couplers; and a THz interposer assembly, comprising: a THz interposer defining a plurality of first ports and a plurality of second ports; and a plurality of THz waveguides disposed within the THz interposer, wherein each of the plurality of THz waveguides extends between a respective one of the plurality of first ports and a respective one of the plurality of second ports, is configured to propagate, between the respective one of the plurality of first ports and the respective one of the plurality of second ports, one or more THz signals having a frequency in a range between 300 GHz and 10 THz with a propagation loss in a range between 0.001 dB per cm and 1.0 dB per cm; wherein the THz interposer assembly is positioned such that at least one of the one or more signal couplers of the at least one of the one or more THz transceivers is coupled to at least one of the plurality of first ports.

In an eighth aspect, the present disclosure includes a method of using a THz interposer assembly, comprising: generating, by a THz transmitter, one or more THz signals having a frequency in a range between 300 GHz and 10 THz; coupling the one or more THz signals into a first THz waveguide disposed within a THz interposer, the first THz waveguide being configured to propagate the one or more THz signals with a propagation loss in a range between 0.001 dB per cm and 1.0 dB per cm; and coupling the one or more THz signals from the first THz waveguide into a signal structure disposed outside of the THz interposer.

In a ninth aspect, the present disclosure includes a method of using a THz interposer assembly, comprising: generating, by a first THz transmitter, one or more first THz signals having a frequency in a range between 300 GHz and 10 THz; generating, by a second THz transmitter, one or more second THz signals having a frequency in a range between 300 GHz and 10 THz; coupling the one or more first THz signals into a first THz waveguide disposed within a THz interposer, the first THz waveguide being configured to propagate the one or more first THz signals with a propagation loss in a range between 0.001 dB per cm and 1 dB per cm; coupling the one or more second THz signals into a second THz waveguide disposed within the THz interposer, the second THz waveguide being configured to propagate the one or more second THz signals with a propagation loss in a range between 0.001 dB per cm and 1.0 dB per cm; coupling the one or more first THz signals from the first THz waveguide into a first signal structure disposed outside of the THz interposer; and coupling the one or more second THz signals from the second THz waveguide into a second signal structure disposed outside of the THz interposer.

In a tenth aspect, the present disclosure includes a method of making a THz interposer assembly, comprising: etching a plurality of base wafers to define a sidewall portion of a plurality of waveguide channels; etching a waveguide core wafer to define a plurality of waveguide cores and a plurality of support structures; and bonding the plurality of base wafers and the waveguide core wafer such that each of the plurality of waveguide cores are enclosed within the respective one of the plurality of waveguide channels to form a plurality of THz waveguides; wherein each of the plurality of THz waveguides extends between a respective one of a plurality of first ports and a respective one of a plurality of second ports and is configured to propagate, between the respective one of the plurality of first ports and the respective one of the plurality of second ports, one or more THz signals having a frequency in a range between 300 GHz and 10 THz with a propagation loss in a range between 0.001 dB per cm and 1.0 dB per cm.

The foregoing summary provides an overview of certain selected embodiments disclosed herein, and is not intended to describe every aspect, embodiment, feature, or advantage of the disclosure exhaustively or comprehensively. Therefore, this summary should not be construed in such a way to limit the scope of this disclosure or to limit the scope of the claims. The details of one or more embodiments disclosed herein are set forth in the accompanying drawings and descriptions below. Other aspects, features, embodiments, and advantages will become readily apparent in view of the description, the drawings, and the claims set forth herein.

Implementations of the above techniques include methods, apparatus, systems, and computer program products described herein. One such computer program product is suitably embodied in a non-transitory computer-readable medium that stores instructions executable by one or more processors. The instructions are configured to cause the one or more processors to perform the above-described actions.

The details of one or more embodiments of the subject matter of this specification are set forth in the accompanying drawings and the description below. Other aspects, features and advantages will become apparent from the description, the drawings, and the claims.

### BRIEF DESCRIPTION OF THE DRAWINGS

The accompanying drawings, which are incorporated in and constitute a part of this specification, illustrate one or more embodiments described herein and, together with the description, explain these embodiments. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a frequency-wavelength diagram of the electromagnetic (EM) spectrum;

FIG. 2 is a block diagram of an exemplary embodiment of a transport network constructed in accordance with the present disclosure;

FIG. 3 is a block diagram of an exemplary embodiment of a user device of the transport network shown in FIG. 2;

FIG. 4 is a block diagram of an exemplary embodiment of a network administrator device of the transport network shown in FIG. 2;

FIG. 5 is a block diagram of an exemplary embodiment of a first network element of the transport network shown in FIG. 2;

FIG. 6A is a perspective view of an exemplary embodiment of a landing connector having multiple waveguide paths, constructed in accordance with the present disclosure;

FIG. 6B is a cross-sectional view of an exemplary embodiment of the landing connector of FIG. 6A, taken along the line 6B-6B and in the direction of the arrows;

FIG. 6C is a cross-sectional view of the landing connector of FIG. 6B, taken along the line 6C-6C and in the direction of the arrows;

FIG. 6D is a bottom view of an exemplary embodiment of the landing connector of FIG. 6A constructed in accordance with the present disclosure;

FIG. 7 is a diagram of an exemplary embodiment of an interference simulation constructed in accordance with the present disclosure;

FIG. 8 is a diagram of an exemplary embodiment of a guide system constructed in accordance with the present disclosure;

FIG. 9A is a perspective view of a first horn of the guide system depicted in FIG. 8;

FIG. 9B is a side-view of the first horn of FIG. 8;

FIG. 9C is a side view of the first horn of FIG. 8;

FIG. 9D is a cross-section view of the first horn of FIG. 8 taken along the line 9D-9D and in the direction of the arrows;

FIG. 9E is a bottom view of the first horn of FIG. 8;

FIG. 10 is a cross-section view of an exemplary embodiment of a second horn of the guide system of FIG. 8 constructed in accordance with the present disclosure;

FIG. 11 is a perspective view of an exemplary embodiment of a multi-guide landing connector constructed in accordance with the present disclosure;

FIG. 12 is a graph of an exemplary embodiment of a calculated transmission through a 20-degree bend in a waveguide (such as in the first bend and the second bend of FIG. 8) at varying bending radii;

FIG. 13 is a diagram of an exemplary embodiment of a performance simulation constructed in accordance with the present disclosure;

FIG. 14 is a block diagram of an exemplary embodiment of a second guide system constructed in accordance with the present disclosure;

FIG. 15 is a block diagram of an exemplary embodiment of a third guide system constructed in accordance with the present disclosure;

FIG. 16 is a cross-sectional view of an exemplary embodiment of a first fiber array constructed in accordance with the present disclosure;

FIG. 17 is a perspective view of an exemplary embodiment of the first fiber array of FIG. 16, constructed in accordance with the present disclosure;

FIG. 18 is a top-view of an exemplary embodiment of a portion of the first fiber array of FIG. 16, constructed in accordance with the present disclosure;

FIG. 19 is a cross-sectional view of an exemplary embodiment of a second fiber array constructed in accordance with the present disclosure;

FIG. 20 is a perspective view of an exemplary embodiment of the second fiber array of FIG. 19, constructed in accordance with the present disclosure;

FIG. 21 is a top-view of an exemplary embodiment of a portion of the second fiber array of FIG. 19, constructed in accordance with the present disclosure;

FIG. 22 is an exploded isometric view of an exemplary embodiment of a Terahertz (THz) interposer assembly constructed in accordance with the present disclosure, wherein the THz interposer assembly comprises a pair of THz interposers;

FIG. 23A is an isometric view of the THz interposer assembly shown in FIG. 22, wherein a cover has been removed such that a first THz interposer of the pair of THz interposers is visible;

FIG. 23B is a cross-sectional view of the THz interposer assembly shown in FIG. 23A, taken from the line 23B-23B and in the direction of the arrows;

FIG. 23C is another cross-sectional view of the THz interposer assembly shown in FIG. 23A, taken from the line 23C-23C and in the direction of the arrows;

FIG. 23D is another isometric view of the THz interposer assembly shown in FIG. 22, wherein the cover and the first THz interposer have been removed such that a second THz interposer of the pair of THz interposers is visible;

FIG. 23E is a cross-sectional view of the THz interposer assembly shown in FIG. 23D, taken from the line 23E-23E and in the direction of the arrows;

FIG. 24 is an exploded isometric view of another exemplary embodiment of a THz interposer assembly constructed in accordance with the present disclosure, wherein the THz interposer assembly comprises four of the THz interposers;

FIG. 25A is an isometric view of the THz interposer assembly shown in FIG. 24, wherein a cover has been removed such that a first THz interposer of the four THz interposers is visible;

FIG. 25B is another isometric view of the THz interposer assembly shown in FIG. 24, wherein the cover and the first THz interposer have been removed such that a second THz interposer of the four THz interposers is visible;

FIG. 25C is another isometric view of the THz interposer assembly shown in FIG. 24, wherein the cover, the first THz interposer, and the second THz interposer have been removed such that a third THz interposer of the four THz interposers is visible;

FIG. 25D is another isometric view of the THz interposer assembly shown in FIG. 24, wherein the cover, the first THz interposer, the second THz interposer, and the third THz interposer have been removed such that a fourth THz interposer of the four THz interposers is visible;

FIG. 26 is a process flow diagram of an exemplary embodiment of a method of using the THz interposer assembly in accordance with the present disclosure;

FIG. 27 is a process flow diagram of an exemplary embodiment of a method of making the THz interposer assembly in accordance with the present disclosure;

FIG. 28A is an isometric view of a portion of yet another embodiment of a THz interposer assembly constructed in accordance with the present disclosure, incorporating a coplanar stripline (CPS) coupling structure, illustrating a Ground-Signal-Ground (GSG) configuration transition to a balanced Ground-Signal (GS) configuration for evanescent coupling of THz signals into or out of a THz waveguide through a dielectric substrate;

FIG. 28B is an isometric view of a portion of yet another exemplary embodiment of the THz interposer incorporating a CPS coupling structure as shown in FIG. 28A, illustrating the GS configuration being in a coplanar relationship with the THz waveguide and directly coupling THz signals into or out of the THz waveguide;

FIG. 28C is a partial top view of the CPS coupling structure shown in FIG. 28B, illustrating a first expansion angle of a pair of conductive traces;

FIG. 28D is a partial top view of the CPS coupling structure shown in FIG. 28B, illustrating a second expansion angle of the pair of conductive traces;

FIG. 28E is a partial side view of the CPS coupling structure shown in FIG. 28A, illustrating the THz waveguide of the THz interposer having an evanescent coupling region including a liftoff section;

FIG. 29A is a partial isometric view of an exemplary embodiment of a THz interposer assembly constructed in accordance with the present disclosure, illustrating the THz interposer assembly having a first THz waveguide and a second THz waveguide in a stacked and overlapping configuration to provide a vertical overlap and permit evanescent coupling of THz signals between the first THz waveguide and the second THz waveguide;

FIG. 29B is a cross-sectional view of the stacked and overlapping configuration of the first THz waveguide and the second THz waveguide shown in FIG. 29A, illustrating evanescent coupling between overlapping THz waveguides;

FIG. 30A is a cross-sectional view of a portion of a first base wafer constructed in accordance with the present disclosure at a first instant in time;

FIG. 30B is another cross-sectional view of the portion of the first base wafer shown in FIG. 30B at a second instant in time, wherein an inner conductive layer has been applied to an inner surface of the first base wafer and an outer conductive layer has been applied to an outer surface of the first base wafer;

FIG. 30C is a cross-sectional view of a portion of a first waveguide core wafer constructed in accordance with the present disclosure, wherein the first waveguide core wafer has been etched to define a plurality of suspended waveguide cores;

FIG. 30D is a cross-sectional view of a portion of a seventh THz interposer constructed in accordance with the present disclosure using the first base wafer shown in FIGS. 30A-30B, the first waveguide core wafer shown in FIG. 30C, and a second, inverted base wafer constructed in a similar manner as the first base wafer;

FIG. 30E is a cross-sectional view of a portion of a second waveguide core wafer constructed in accordance with the present disclosure, wherein the second waveguide core wafer has been etched to define a plurality of supported waveguide cores; and

FIG. 30F is a cross-sectional view of a portion of an eighth THz interposer constructed in accordance with the present disclosure using the first base wafer shown in FIGS. 30A-30B, the second waveguide core wafer shown in FIG. 30D, and the second, inverted base wafer shown in FIG. 30D.

### DETAILED DESCRIPTION

The following detailed description refers to the accompanying drawings. The same reference numbers in different drawings may identify the same or similar elements.

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted. The disclosure is capable of other embodiments or of being practiced or carried out in various ways. Also, it is to be understood that the phraseology and terminology employed herein is for purposes of description and should not be regarded as limiting.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, Y, and Z” will be understood to include X alone, V alone, and Z alone, as well as any combination of X, Y, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the disclosure as described herein. Where a range of numerical values is stated herein as being less than a stated value, the range is nevertheless bounded on its lower end by a non-zero value. It is not intended that the scope of the disclosure be limited to the specific values recited when defining a range. All ranges are inclusive and combinable.

As used herein, any reference to “one embodiment,” “an embodiment,” “some embodiments,” “one example,” “for example,” or “an example” means that a particular element, feature, structure, or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

As used herein, “circuitry” may refer to analog and/or digital components, or one or more suitably programmed processors (e.g., microprocessors) and associated hardware and software, or hardwired logic. Also, “circuitry” may perform one or more functions. The term “circuitry” may include hardware, such as a processor (e.g., microprocessor), a combination of hardware and software, and/or the like. Software may include one or more processor-executable instructions that when executed by one or more processors cause the one or more processors to perform a specified function. It should be understood that the algorithms described herein may be stored on one or more non-transitory memories. Exemplary non-transitory memory may include random access memory, read only memory, flash memory, and/or the like. Such non-transitory memory may be electrically based, optically based, and/or the like.

As used herein, “software” may include one or more computer readable instruction that when executed by one or more component (e.g., a processor) causes the component to perform a specified function. It should be understood that the algorithms described herein may be stored on one or more non-transitory computer-readable medium. Exemplary non-transitory computer-readable media may include a non-volatile memory, a volatile memory, a random-access memory (RAM), a read only memory (ROM), a CD-ROM, a hard drive, a solid-state drive, a flash drive, a memory card, a DVD-ROM, a Blu-ray Disk, a laser disk, a magnetic disk, an optical drive, a phase change memory, combinations thereof, and/or the like. Such non-transitory computer-readable media may be electrically based, optically based, magnetically based, material-phase based, resistive based, and/or the like. Further, the messages described herein may be generated by the components and result in various physical transformations.

As used herein, a “mode” refers to a unique distribution of electric and magnetic fields which repeat along the length of a Terahertz (THz) waveguide by which electromagnetic energy may be transported through the THz waveguide. “Single-mode” refers to a THz waveguide designed to carry only one mode of electromagnetic wave. This is achieved by having a narrow core diameter, which allows only one mode of light to propagate at a time. On the other hand, “multi-mode” refers to a THz waveguide designed to carry multiple modes of electromagnetic waves simultaneously. This is possible due to its larger core diameter, which enables multiple modes to be propagated.

As used herein, “Amplitude Modulation” (AM) refers to a form of signal modulation in which data is encoded in an amplitude of a carrier signal in an electromagnetic wave.

As used herein, “Amplitude-Shift Keying” (ASK) refers to a form of AM in which digital data is encoded in an amplitude of a carrier signal, and each symbol (i.e., representing one or more data bit) is sent by transmitting a fixed-amplitude electromagnetic wave at a fixed frequency for a specific time period.

As used herein, “Phase-Shift Keying” (PSK) is a form of signal modulation in which signal data is encoded in a phase of a carrier signal having a constant frequency. “Quadrature PSK” (QPSK) Is a form of PSK in which two data bits (i.e., 00, 01, 10, or 11) are modulated at once, selecting one of four possible carrier phase shifts (i.e., 0°, 90°, 180°, or 270°).

As used herein, “Pulse-Amplitude Modulation” (PAM) refers to a form of AM in which a data signal is encoded in an amplitude of a series of carrier signal pulses. “PAM4” refers to a form of PAM in which a data signal is encoded in an amplitude of a series of carrier signal pulses, in which the amplitude of the carrier signal pulses may be one of four discrete values (i.e., 0, 1, 2, or 3) and each carrier signal pulse represents two data bits (i.e., 00, 01, 10, or 11).

As used herein, “Non-Return-to-Zero” (NRZ) refers to a form of signal modulation in which a binary data signal is encoded in a carrier signal such that ones are represented by a first significant condition (e.g., a positive voltage) and zeroes are represented by a second significant condition (e.g., a negative voltage). “Non-return-to-Zero, Inverted” (NRZI) refers to a form of signal modulation in which the data bits are represented by the presence or absence of a transition at a clock boundary.

As used herein, “Quadrature Amplitude Modulation” (QAM) refers to a form of AM in which two analog message signals or two digital bit streams are encoded in amplitudes of two carrier waves, using either ASK or AM, and the two carrier signals are out of phase with each other by 90°. “QAM 16” refers to a form of QAM in which the carrier signals may exist in one of sixteen discrete states (i.e., symbols) having one of sixteen different amplitude and phase levels representing four data bits (i.e., from 0000 to 1111).

As used herein, “Trellis Coded Modulation” (TCM) refers to a form of signal modulation in which a binary data signal is encoded in a phase of a constant amplitude carrier signal. The transmitted signal is created by convolutionally encoding the binary data signal and mapping the result to a signal constellation.

As used herein, “Rayleigh range” refers to the distance along the propagation direction of a beam from the waist to the place where the area of the cross section is doubled.

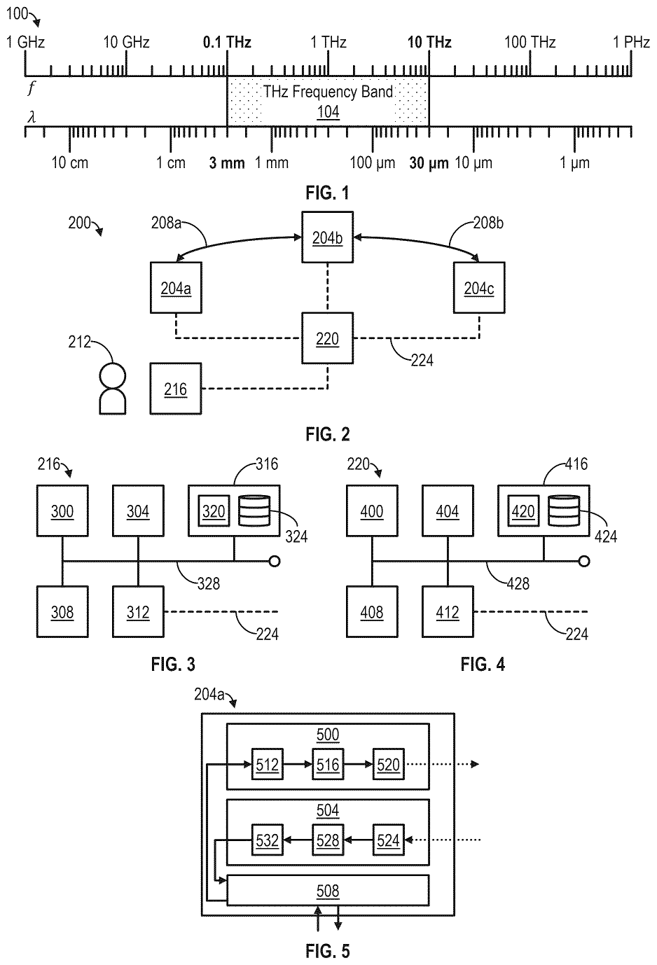

As used herein, “THz waveguide” refers to a structure that guides electromagnetic waves by restricting transmission of energy in a particular direction and having a propagation loss in a range between 0.001 and 1.0 decibels (dB) per centimeter (cm) in the THz frequency band 104 (shown in FIG. 1). In the context of the present disclosure, “THz waveguide” may refer to a dielectric rod waveguide having a waveguide core operable to propagate RF signals in the THz frequency band or a routed waveguide operable to propagate RF signals in the THz frequency band.

As used herein, “diameter” refers to a straight line passing from side to side through the center of a body or figure. In some embodiments, the body or figure has a circular shape having a single diameter or an elliptical shape having multiple different diameters.

As used herein, “data” refers to quantities, characters, or symbols on which operations are performed by a computer. Data can be recorded on a non-transitory computer readable medium, such as random-access memory and/or read only memory. The random-access memory and/or read only memory may be implemented on semiconductor, magnetic, optical, or mechanical recording media. An example of data is client data, e.g., data provided by a client in connection with a telecommunication service and/or a storage service.

Referring now to the drawings, and in particular to FIG. 1, shown therein is a frequency-wavelength diagram of the electromagnetic (EM) spectrum 100. As shown in FIG. 1, frequency and wavelength have an inverse relationship; that is, as the frequency of a signal increases, the wavelength of the signal decreases, and vice versa. The present disclosure is generally related to transport networks (shown in FIG. 2) and network elements (shown in FIG. 2) that communicate using signals comprising radiated electromagnetic waves coupled into THz waveguides. Such signals generally have a frequency in what is referred to as the (THz frequency band 104, which corresponds to frequencies in a range between 0.1 THz and 10 THz and wavelengths in a range between 3 millimeters (mm) and 30 micrometers (μm). However, in some embodiments described herein, the THz frequency band 104 may have a different range, such as between 300 Gigahertz (GHz) and 10 THz, for example.

Referring now to FIG. 2, shown therein is a block diagram of an exemplary embodiment of a transport network 200 constructed in accordance with the present disclosure. As shown in FIG. 2, the transport network 200 generally comprises a plurality of network elements 204a-n (hereinafter, the “network elements 204”) (e.g., a first network element 204a, a second network element 204b, and a third network element 204c shown in FIG. 2) which may communicate with each other using one or more THz waveguides 208a-n (hereinafter, the “THz waveguides 208”) (e.g., a first THz waveguide 208a and a second THz waveguide 208b shown in FIG. 2).

While three of the network elements 204 are shown in FIG. 2, it should be understood that the transport network 200 may comprise a number of the network elements 204 that is greater or less than three. Further, while two of the THz waveguides 208 are shown in FIG. 2, it should be understood that the transport network 200 may comprise a number of the THz waveguides 208 that is greater or less than two.

In some embodiments of the transport network 200, a user 212 may interact with the transport network 200 using a user device 216 that may be used to request, such as from a network administrator device 220, a user interface application (shown in FIG. 3) which may be operable to accept input from the user 212 which may be transmitted to at least one of the network elements 204. In some such embodiments, the network administrator device 220 may be connected to the transport network 200 and the user device 216 via a communication network 224.

The communication network 224 may interface by optical and/or electronic interfaces and/or use a variety of network topographies and/or protocols to permit bidirectional interface and/or communication of signals and/or data between the network elements 204, the user device 216, and the network administrator device 220. In some embodiments, the communication network 224 may also be formed at least partially within one or more of the THz waveguides 208. The communication network 224 may interface with the network elements 204, the user device 216, and the network administrator device 220 in a variety of ways. For example, in some embodiments, the communication network 224 may be the World Wide Web (i.e., the Internet). In some such embodiments, a user interface of the transport network 200 may be delivered through a series of web pages or private internal web pages of a company or corporation, which may be written in Hypertext Markup Language (HTML), Hypertext Preprocessor (PHP), or JavaScript, for example, and may be accessible by the user device 216. It should be noted that the user interface of the transport network 200 may be another type of interface including, but not limited to, a Windows-based application, a server-based application, a tablet-based application, a mobile web interface, an application running on a mobile device, a virtual-reality interface, an augmented-reality interface, and/or the like.

While the communication network 224 is described above as being the World Wide Web (i.e., the Internet), it should be noted that the communication network 224 may be almost any type of network and may be implemented as a Local Area Network (LAN), a Wide-Area Network (WAN), a Low-Power Wide-Area Network (LPWAN), a Long Range (LoRa) network, a metropolitan network, a wireless network, a Wi-Fi network, a cellular network, a Bluetooth network, a Global System for Mobile Communications (GSM) network, a Code Division Multiple Access (CDMA) network, a Third Generation (3G) network, a Fourth Generation (4G) network, a Long Term Evolution (LTE) network, a Fifth Generation (5G) network, a satellite network, a radio network, an optical network, a cable network, a public switched telephone network, an Ethernet network, a short-wave wireless network, a long-wave wireless network, combinations thereof, and/or the like.

The number of devices and/or networks illustrated in FIG. 2 is provided for explanatory purposes. In practice, there may be additional devices and/or networks, fewer devices and/or networks, different devices and/or networks, or differently arranged devices and/or networks than are shown in FIG. 2. Furthermore, two or more of the devices illustrated in FIG. 2 may be implemented within a single device, or a single device illustrated in FIG. 2 may be implemented as multiple, distributed devices. Additionally, or alternatively, one or more of the devices of the transport network 200 may perform one or more functions described as being performed by another one or more of the devices of the transport network 200. Devices of the transport network 200 may interconnect via wired connections, wireless connections, or a combination thereof.

Referring now to FIG. 3, shown therein is a block diagram of an exemplary embodiment of the user device 216 of the transport network 200 constructed in accordance with the present disclosure. In some embodiments, the user device 216 may include, but is not limited to, embodiment as a personal computer, a cellular telephone, a smart phone, a network-capable television set, a tablet, a laptop computer, a desktop computer, a network-capable handheld device, a server, a digital video recorder, a wearable network-capable device, a virtual reality (VR)/augmented reality (AR) device, and/or the like.

As shown in FIG. 3, the user device 216 generally includes one or more user input devices 300a-n (hereinafter, the “user input device 300”), one or more user output devices 304a-n (hereinafter, the “user output device 304”), one or more user processors 308a-n (hereinafter, the “user processor 308”), one or more user communication devices 312a-n (hereinafter, the “user communication device 312”), and one or more user memories 316a-n (hereinafter, the “user memory 316”) storing one or more user software applications 320a-n (hereinafter, the “user software application 320”), comprising processor-executable instructions, and/or one or more user databases 324a-n (hereinafter, the “user database 324”). The user input device 300, the user output device 304, the user processor 308, the user communication device 312, and the user memory 316 may be connected via a user path 328 such as a data bus that permits communication among the components of the user device 216.

The user input device 300 may be capable of receiving information input from the user processor 308 and/or the user 212, and transmitting such information to other components of the user device 216 and/or the communication network 224. The user input device 300 may include, but is not limited to, embodiment as a keyboard, a touchscreen, a mouse, a trackball, a microphone, a camera, a fingerprint reader, an infrared port, an optical port, a cell phone, a smart phone, a Personal Digital Assistant (PDA), a remote control, a fax machine, a wearable communication device, a network interface, combinations thereof, and/or the like, for example.

The user output device 304 may be capable of outputting information in a form perceivable by the user processor 308 and/or the user 212. The user output device 304 may include, but is not limited to, embodiment as a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and/or the like, for example. It is to be understood that in some exemplary embodiments, the user input device 300 and the user output device 304 may be implemented as a single device, such as, for example, a touchscreen of a computer, a tablet, or a smartphone. It is to be further understood that as used herein the term “user” (i.e., the user 212) is not limited to a human being, and may comprise a computer, a server, a website, a processor, a network interface, a user terminal, a virtual computer, combinations thereof, and/or the like, for example. The user output device 304 may display the user interface on the user device 216.

The user processor 308 may include, but is not limited to, embodiment as a processor, a microprocessor, a mobile processor, a System on a Chip (SoC), a Central Processing Unit (CPU), a Microcontroller (MCU), a Digital Signal Processor (DSP), an Application Specific Integrated Circuit (ASIC), a Field Programmable Gate Array (FPGA), a Tensor Processing Unit (TPU), a Graphics Processing Unit (GPU), a Neural Processing Unit (NPU), a combination of hardware and software, and/or the like. The user processor 308 may be capable of communicating with the user input device 300, the user output device 304, the user communication device 312, and/or the user memory 316 via the user path 328. The user processor 308 may include one or more of the user processor 308 working together or independently and located locally or remotely (e.g., accessible via the communication network 224).

The user communication device 312, in communication with the user processor 308, may interface with the communication network 224. For example, the user processor 308 may be capable of communicating via the communication network 224 by exchanging signals (e.g., analog, digital, optical, and/or the like) via one or more ports (e.g., physical or virtual ports) using a network protocol to communicate signals and/or data with the network administrator device 220 and/or transport network 200.

The user memory 316 may comprise one or more non-transitory processor-readable media. The user memory 316 may store the user software application 320 that, when executed by the user processor 308, causes the user device 216 to perform an action such as communicate with or control one or more component of the user device 216 and/or, via the communication network 224, the transport network 200. The user memory 316 may include one or more of the user memory 316 working together or independently to store processor-executable code and may be located locally or remotely (e.g., accessible via the communication network 224). The user software application 320 may include, for example, a web browser capable of accessing a website and/or communicating signals and/or data over a wireless or wired network (e.g., the communication network 224) and/or the like.

The user database 324 may be a relational database, a time-series database, a vector database, a non-relational database, or the like. Examples of such databases comprise DB2®, Microsoft® Access, Microsoft® SQL Server, Oracle®, MySQL, PostgreSQL, MongoDB, Apache Cassandra, Weaviate, and the like. It should be understood that these examples have been provided for the purposes of illustration only and should not be construed as limiting the presently disclosed inventive concepts. The user database 324 may be centralized or distributed across multiple systems.

The number of devices and/or networks illustrated in FIG. 3 is provided for explanatory purposes. In practice, there may be additional devices and/or networks, fewer devices and/or networks, different devices and/or networks, or differently arranged devices and/or networks than are shown in FIG. 3. Furthermore, two or more of the components or devices illustrated in FIG. 3 may be implemented within a single component or device, or a single component or device illustrated in FIG. 3 may be implemented as multiple, distributed components or devices. Additionally, or alternatively, one or more of the components or devices of the user device 216 may perform one or more functions described as being performed by another one or more of the components or devices of the user device 216. Components or devices of the user device 216 may interconnect via wired connections, wireless connections, or a combination thereof. For example, in one embodiment, the user device 216 and the network administrator device 220 may be integrated into the same device; that is, the user device 216 may perform functions and/or processes described as being performed by the network administrator device 220, described in more detail below.

Referring now to FIG. 4, shown therein is a block diagram of an exemplary embodiment of the network administrator device 220 of the transport network 200 constructed in accordance with the present disclosure. In some embodiments, the network administrator device 220 may include, but is not limited to, embodiment as a personal computer, a cellular telephone, a smart phone, a network-capable television set, a tablet, a laptop computer, a desktop computer, a network-capable handheld device, a server, a digital video recorder, a wearable network-capable device, a VR/AR device, and/or the like.

As shown in FIG. 4, the network administrator device 220 generally includes one or more administrator input devices 400a-n (hereinafter, the “administrator input device 400”), one or more administrator output devices 404 a-n (hereinafter, the “administrator output device 404”), one or more administrator processors 408a-n (hereinafter, the “administrator processor 408”), one or more administrator communication devices 412a-n (hereinafter, the “administrator communication device 412”), and one or more administrator memories 416a-n (hereinafter, the “administrator memory 416”) storing one or more administrator software applications 420a-n (hereinafter, the “administrator software application 420”) comprising processor-executable instructions and/or one or more administrator databases 424a-n (hereinafter, the “administrator database 424”). The administrator input device 400, the administrator output device 404, the administrator processor 408, the administrator communication device 412, and the administrator memory 416 may be connected via an administrator path 428 such as a data bus that permits communication among the components of the network administrator device 220.

The administrator input device 400 may be capable of receiving information input from the administrator processor 408 and/or the user 212, and transmitting such information to other components of the network administrator device 220 and/or the communication network 224. The administrator input device 400 may include, but is not limited to, embodiment as a keyboard, a touchscreen, a mouse, a trackball, a microphone, a camera, a fingerprint reader, an infrared port, an optical port, a cell phone, a smart phone, a PDA, a remote control, a fax machine, a wearable communication device, a network interface, combinations thereof, and/or the like, for example.

The administrator output device 404 may be capable of outputting information in a form perceivable by the administrator processor 408 and/or the user 212. The administrator output device 404 may include, but is not limited to, embodiment as a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and/or the like, for example. It is to be understood that in some exemplary embodiments, the administrator input device 400 and the administrator output device 404 may be implemented as a single device, such as, for example, a touchscreen of a computer, a tablet, or a smartphone. The administrator output device 404 may display the user interface on the network administrator device 220.

The administrator processor 408 may include, but is not limited to, embodiment as a processor, a microprocessor, a mobile processor, an SoC, a CPU, an MCU, a DSP, an ASIC, an FPGA, a TPU, a GPU, an NPU, a combination of hardware and software, and/or the like. The administrator processor 408 may be capable of communicating with the administrator input device 400, the administrator output device 404, the administrator communication device 412, and/or the administrator memory 416 via the administrator path 428. The administrator processor 408 may include one or more of the administrator processor 408 working together or independently and located locally or remotely (e.g., accessible via the communication network 224).

The administrator communication device 412, in communication with the administrator processor 408, may interface with the communication network 224. For example, the administrator processor 408 may be capable of communicating via the communication network 224 by exchanging signals (e.g., analog, digital, optical, and/or the like) via one or more ports (e.g., physical or virtual ports) using a network protocol to communicate signals and/or data with the user device 216 and/or the transport network 200.

The administrator memory 416 may comprise one or more non-transitory processor-readable media. The administrator memory 416 may store the administrator software application 420 that, when executed by the administrator processor 408, causes the network administrator device 220 to perform an action such as communicate with or control one or more component of the network administrator device 220 and/or, via the communication network 224, the transport network 200. The administrator memory 416 may include one or more of the administrator memory 416 working together or independently to store processor-executable code and may be located locally or remotely (e.g., accessible via the communication network 224). The administrator software application 420 may include, for example, a web browser capable of accessing a website and/or communicating signals and/or data over a wireless or wired network (e.g., the communication network 224) and/or the like.

The administrator database 424 may be a relational database, a time-series database, a vector database, a non-relational database, or the like. Examples of such databases comprise DB2®, Microsoft® Access, Microsoft® SQL Server, Oracle®, MySQL, PostgreSQL, MongoDB, Apache Cassandra, Weaviate, and the like. It should be understood that these examples have been provided for the purposes of illustration only and should not be construed as limiting the presently disclosed inventive concepts. The administrator database 424 may be centralized or distributed across multiple systems.

The number of devices and/or networks illustrated in FIG. 4 is provided for explanatory purposes. In practice, there may be additional devices and/or networks, fewer devices and/or networks, different devices and/or networks, or differently arranged devices and/or networks than are shown in FIG. 4. Furthermore, two or more of the components or devices illustrated in FIG. 4 may be implemented within a single component or device, or a single component or device illustrated in FIG. 4 may be implemented as multiple, distributed components or devices. Additionally, or alternatively, one or more of the components or devices of the network administrator device 220 may perform one or more functions described as being performed by another one or more of the components or devices of the network administrator device 220. Components or devices of the network administrator device 220 may interconnect via wired connections, wireless connections, or a combination thereof. For example, in one embodiment, the network administrator device 220 and the user device 216 may be integrated into the same device; that is, the network administrator device 220 may perform functions and/or processes described as being performed by the user device 216.

Referring now to FIG. 5, shown therein is a block diagram of an exemplary embodiment of the first network element 204a shown in FIG. 2. However, it should be understood that the description below may be applicable to any of the network elements 204 described herein. As shown in FIG. 5, the first network element 204a—and, therefore, any of the network elements 204 described herein—may comprise one or more of a transmitter 500 and a receiver 504 in addition to a controller 508.

The transmitter 500 may be generally operable to receive outbound baseband signals (i.e., conducted electrical signals) having outbound client data encoded therein from a source external to the transmitter 500 (e.g., the controller 508), generate outbound THz signals (i.e., radiated electromagnetic waves having a frequency in the THz frequency band 104) based on the outbound baseband signals, and transmit and/or couple the outbound THz signals into one of the THz waveguides 208 (e.g., the first THz waveguide 208a).

As used herein, “data” refers to quantities, characters, or symbols on which operations are performed by a computer. Data can be recorded on a non-transitory computer readable medium, such as random-access memory and/or read only memory. The random-access memory and/or read only memory may be implemented on semiconductor, magnetic, optical, or mechanical recording media. An example of data is client data, e.g., data provided by a client in connection with a telecommunication service and/or a storage service.

As shown in FIG. 5, the transmitter 500 may comprise a client-side input 512 operable to receive the outbound baseband signals, transmitter circuitry 516 operable to receive the outbound baseband signals from the client-side input 512 and modulate the outbound client data onto a carrier signal having one or more frequencies in the THz frequency band 104 (i.e., a range between 0.1 THz and 10 THz and wavelengths in a range between 3 mm and 30 μm) to generate antenna feed signals based on the outbound baseband signals and incorporating the outbound client data configured for coherent detection, and a transmitter antenna array 520 comprising one or more transmitter antennas and operable to receive the antenna feed signals from the transmitter circuitry 516, generate the outbound THz signals based on the antenna feed signals, and transmit and/or couple the outbound THz signals into one of the THz waveguides 208 (e.g., the first THz waveguide 208a). In some embodiments described herein, the THz frequency band 104 may include frequencies in a different range, such as between 300 GHz and 10 THz, for example. The outbound client data can be modulated onto the carrier signal according to a specification of one or more of n-level pulse amplitude modulation (PAMn), m-level quadrature amplitude modulation (mQAM), and quadrature phase shift keying (QPSK). In some embodiments, the one or more transmitter antennas include a metallic radiating element constructed of copper, for example, which does not include a photoconductive element, and is operable to generate the outbound THz signals without optical excitation.

The receiver 504 may be generally operable to receive, detect, and/or decode inbound THz signals from one of the THz waveguides 208 (e.g., the first THz waveguide 208a), generate inbound baseband signals based on the inbound THz signals, and transmit the inbound baseband signals having inbound client data encoded therein to a destination external to the receiver 504 (e.g., the controller 508). As shown in FIG. 5, the receiver 504 may comprise a receiver antenna array 524 comprising one or more receiver antennas and operable to receive, detect, and/or decode the inbound THz signals from one of the THz waveguides 208 (e.g., the first THz waveguide 208a) and generate antenna output signals based on the inbound THz signals, receiver circuitry 528 operable to receive the antenna output signals from the receiver antenna array 524, demodulate the antenna output signals using a coherent demodulation scheme preferably using a local oscillator signal, generated by the receiver circuitry 528, tuned to the frequency of the carrier signals, and generate inbound baseband signals based on the antenna output signals, and a client-side output 532 operable to receive the inbound baseband signals from the receiver circuitry 528 and send the inbound baseband signals to a destination external to the receiver 504 (e.g., the controller 508). In some embodiments, the one or more receiver antennas include a metallic element constructed of copper, for example, which does not include a photoconductive element, and is operable to receive, detect, and generate electrical signals from the inbound THz signals passing through one of the THz waveguides 208 without optical excitation or a photovoltaic.

The controller 508 may be generally operable to regulate one or more operating parameters of the transmitter 500, the receiver 504, and/or the first network element 204a and/or send and/or receive signals and/or data to and/or from the transmitter 500 and/or the receiver 504.

Nonexclusive examples of how to make and use the transmitter 500 (including but not limited to the client-side input 512, the transmitter circuitry 516, and the transmitter antenna array 520) and the receiver 504 (including but not limited to the receiver antenna array 524, the receiver circuitry 528, and the client-side output 532) are further described in U.S. patent application Ser. No. 18/927,535, titled “Fiber-Coupled Terahertz RF Transceiver System”, filed on Oct. 25, 2024, the entire content of which is hereby incorporated herein by reference in its entirety.

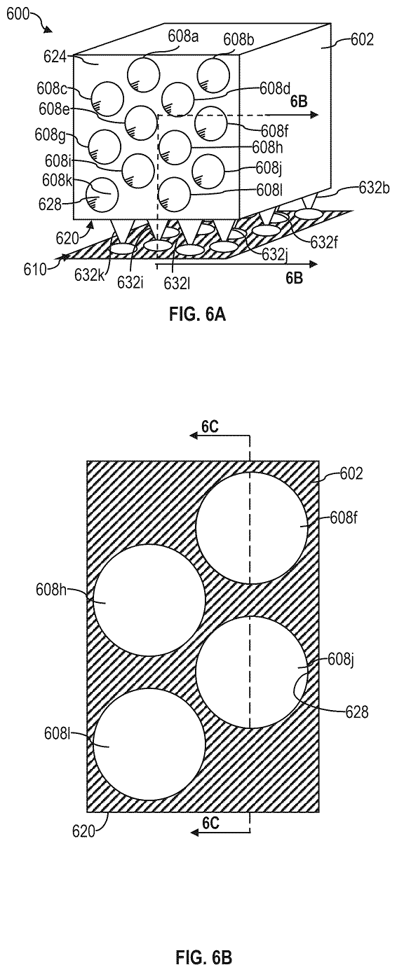

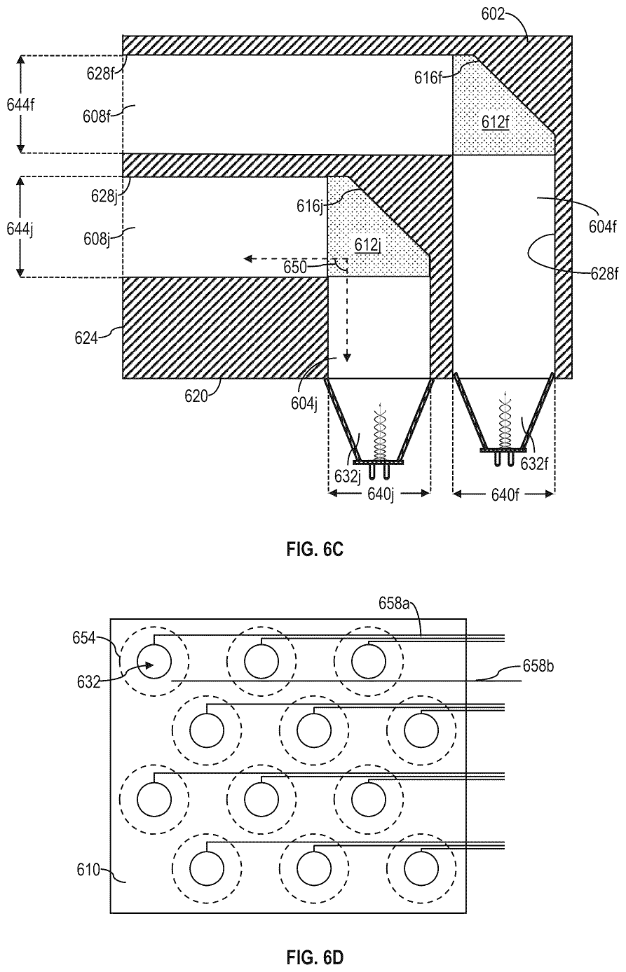

Referring now to FIGS. 6A-6D, in combination, shown therein are views of an exemplary embodiment of a landing connector 600 constructed and used in accordance with the present disclosure. The landing connector 600 generally comprises a landing body 602 having a first waveguide 604, a second waveguide 608 intersecting the first waveguide 604 at an intersection 612, and a reflector 616 positioned at the intersection 612. The landing body 602 may be constructed such that the landing body 602 may be operable to interface with an originating substrate 610. As used herein, the arrangement of the first waveguide 604, the second waveguide 608 intersecting the first waveguide 604 at the intersection 612, and a reflector 616 positioned at the intersection 612, may be referred to herein as a waveguide path. In some embodiments, the landing connector 600 may comprise multiple waveguide paths, e.g., multiples of the first waveguides 604, second waveguides 608, intersections 612, and reflectors 616.

In one embodiment, the landing body 602 comprises a uniform material having a first surface 620, a second surface 624 orthogonal to the first surface 620. The first waveguide 604 may extend from the first surface 620 to the intersection 612 and the second waveguide 608 may extend from the second surface 624 to the intersection 612 having the reflector 616, within the landing body 602. The first waveguide 604 and the second waveguide 608, extending through the landing body 602 may form an interior surface 628.

In one embodiment, although illustrated as circular, the second waveguide 608 and/or the first waveguide 604 may be constructed as rectangularly shaped waveguides, elliptically shaped waveguides, and/or the like.

In one embodiment, the interior surface 628 may be constructed, for example, of a conductive material. In some embodiments, the interior surface 628 may be formed of the uniform material of the landing body 602. The landing body 602 may be constructed of a conductive material. The conductive material may include, for example, an electrically conductive material such as copper, silver, indium tin oxide (ITO), or gold. In other embodiments, the landing body 602 may be constructed of a non-conductive material, and the interior surface 628 may be coated with a conductive material.

In one embodiment, the first waveguide 604 may be configured to receive at least a portion of an antenna 632. In other embodiments, the first waveguide 604 may be configured to adjoin the landing connector 600 such that a cross-sectional dimension 636 of the first waveguide 604 is similar to a first cross-sectional dimension 640 of the antenna 632, as shown in FIG. 6C.

Referring to FIG. 6A, shown therein is a perspective view of an exemplary embodiment of the landing connector 600 having multiple waveguide paths, constructed in accordance with the present disclosure. As shown in FIG. 6A, the landing connector 600 may include the landing body 602 having multiple waveguide paths comprising the first waveguides 604 intersecting multiples of the second waveguides 608 at respective reflectors 616 positioned at respective intersections 612. For example, as shown in FIG. 6A, the landing connector 600 may include the landing body 602 comprising second waveguides 608a-l intersecting respective first waveguides 604a-l (shown in FIGS. 6C-6D) and associated with respective antennae 632a-l. While the landing connector 600 is shown having 12 waveguide paths, it should be understood that the landing connector may comprise as few as one waveguide path and as many waveguide paths as antennae 632 on the originating substrate 610.

In one embodiment, the landing connector 600 may further comprise one or more coupling member operable to fasten the landing connector 600 onto the originating substrate 610. The originating substrate 610 may be, for example, one or more of: a printed circuit board (PCB), integrated circuit (IC), a substrate integrated waveguide, a redistribution layer, or a combination thereof, and/or the like. In some embodiments, the originating substrate 610 may be, for example, a heatsink, e.g., positioned on a PCB or IC. In some embodiments, the originating substrate 610 may be an organic or a ceramic substrate. In some embodiments, the one or more coupling member may be configured to position the landing connector 600 in relation to one or more antenna 632 as described herein.

Referring now to FIG. 6B, shown therein is a cross-sectional view of an exemplary embodiment of the landing connector 600, taken from the line 6B-6B and in the direction of the arrows. The second waveguides 608, shown as second waveguides 608f, h, j, and l, may be arranged in an offset pattern such that adjacently disposed second waveguides 608 in a first direction are aligned while adjacently disposed second waveguides 608 in a second direction are offset from one another. In other embodiments, the second waveguides 608 may be disposed aligned and equidistant from adjacently disposed second waveguides 608. In other embodiments, the second waveguides 608 may be arranged such that an optimized number of second waveguides 608 may be constructed within the landing body 602.

Referring now to FIG. 6C, shown therein is a cross-sectional view of the landing connector 600, taken from the line 6C-6C and in the direction of the arrows. In some embodiments, the first waveguide 604 may be constructed with a first cross-sectional dimension 640 configured to receive at least a portion of a respective antenna 632 and to receive a radiated electromagnetic wave from the antenna 632. For example, as shown in FIG. 6C, the first waveguide 604f has a first cross-sectional dimension 640f configured to receive at least a portion of the antenna 632f (such as the radiator) and configured to interface with the antenna 632f to receive the radiated electromagnetic wave from the antenna 632f.

In one embodiment, the radiated electromagnetic wave comprises electromagnetic energy having data encoded within a carrier frequency in the THz frequency band 104 (e.g., a range between 300 GHz and 10 THz). In some embodiments, the radiated electromagnetic wave may be a linear-polarized wave, a circular-polarized wave, an elliptical-polarized wave, and/or the like. In some embodiments, the radiated electromagnetic wave may comprise at least one of a TE10 mode and an HE11 mode, e.g., where the electric field is vertical and falls off to 0 at the edges and the magnetic field is horizontal.

In other embodiments, the first waveguide 604 may be constructed with a first cross-sectional dimension 640 configured to be disposed adjacent the antenna 632 and to receive the radiated electromagnetic wave from the antenna 632. For example, as shown in FIG. 6C, the first waveguide 604j has a first cross-sectional dimension 640j configured to be disposed adjacent the antenna 632j and configured to interface with the antenna 632j to receive the radiated electromagnetic wave from the antenna 632j.

In some embodiments, the first waveguide 604 of a particular waveguide path may be constructed with the first cross-sectional dimension 640 and the second waveguide 608 of the particular waveguide path may be constructed with a second cross-sectional dimension 644. For example, as shown in FIG. 6C, the first waveguide 604f may be constructed having the first cross-sectional dimension 640f and the second waveguide 608f may be constructed having the second cross-sectional dimension 644f, while the first waveguide 604j may be constructed having the first cross-sectional dimension 640j and the second waveguide 608j may be constructed having the second cross-sectional dimension 644j.

In some embodiments, the first cross-sectional dimension 640 may be the same as the second cross-sectional dimension 644, while in other embodiments the first cross-sectional dimension 640 may have a different dimension than the second cross-sectional dimension 644. Further, a first cross-sectional dimension 640 or second cross-sectional dimension 644 of a first waveguide path may be the same as or different from the dimension of a respective first cross-sectional dimension 640 or second cross-sectional dimension 644 of a second waveguide path. For example, the second cross-sectional dimension 644f may be the same or different from the second cross-sectional dimension 644j. Similarly, the first cross-sectional dimension 640f may be the same or different from the first cross-sectional dimension 640j. Furthermore, in some embodiments, the first cross-sectional dimension 640f may have the same dimension as the first cross-sectional dimension 640j, while the second cross-sectional dimension 644f may have a different dimension as the second cross-sectional dimension 644j.

In one embodiment, the first cross-sectional dimension 640 and the second cross-sectional dimension 644 may be selected based on a wavelength of the radiated electromagnetic wave. For example, the first cross-sectional dimension 640 and the second cross-sectional dimension 644 may be in a range between ¼ wavelengths and 50 wavelengths of the radiated electromagnetic wave.

As shown in FIG. 6C, the first waveguide 604 may intersect the second waveguide 608 at an angle of intersection (referred to as an intersection angle 650). The intersection angle 650 may be about 90 degrees. In some embodiments, the intersection angle 650 may be between about 55 degrees and about 135 degrees.

The reflector 616 may be positioned at the intersection 612. The reflector 616 may be constructed of a reflective material, such as a conductive material. The reflector 616 is configured to reflect a radiated electromagnetic wave having data encoded within a carrier frequency in a range between 300 GHz and 10 THz. In some embodiments, the radiated electromagnetic wave may be configured to be received and decoded by a coherent receiver. In some embodiments, the reflector 616 is constructed similarly to the conductive material, described above in more detail.

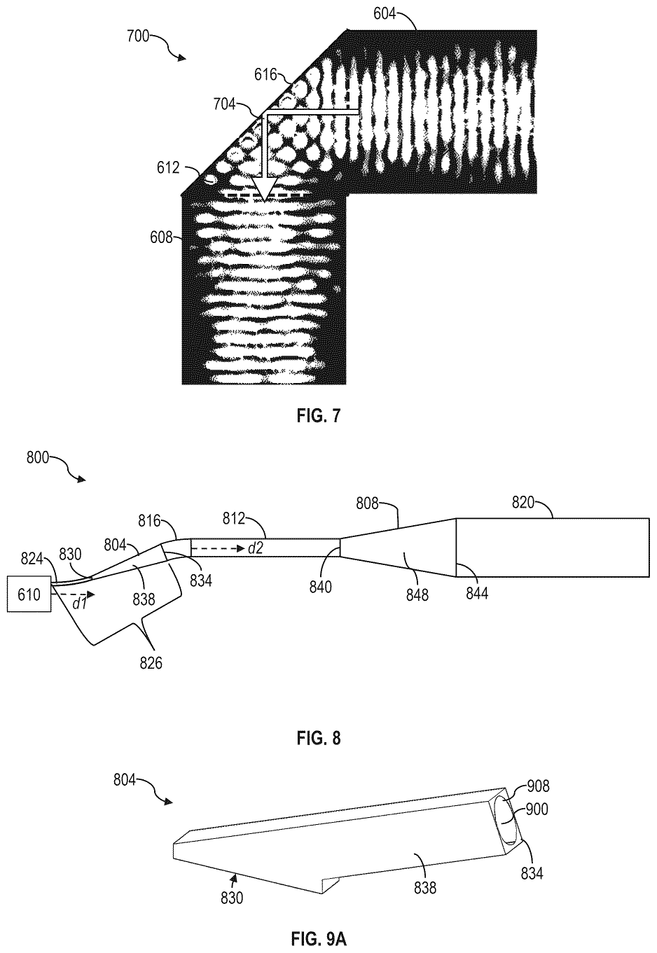

As shown in FIG. 6C, a reflector 616f may be positioned at intersection 612f such that the radiated electromagnetic wave traveling along the first waveguide 604f and encountering the reflector 616f is reflected along the second waveguide 608f, e.g., at the intersection angle 650, as shown in FIG. 7.

In some embodiments, the landing connector 600 may further comprise a second reflector. The second reflector may be disposed apart from the reflector 616 such that a third waveguide may intersect one of the first waveguide 604 and the second waveguide 608 at a second intersection. The second reflector may be disposed in the second intersection in accordance with the disposition of the reflector 616 within the intersection 612, detailed above.

Referring now to FIG. 6D, shown therein is a top view of an exemplary embodiment of the originating substrate 610 constructed in accordance with the present disclosure. As shown in FIG. 6D, one or more of the antennae 632 may further include a plurality of ground planes 654. Only one of the antennas 632 and ground planes 654 are labeled in FIG. 6D for purposes of clarity. Each ground plane 654 may be coupled to a respective trace 658 of a plurality of traces 658 on the originating substrate 610. The traces 658 may include, for example, a first trace 658a to the antenna 632, and a second trace 658b to a corresponding ground plane 654 adjacent to and electrically coupled with a particular one of the ground planes 654 to supply a signal to generate the radiated electromagnetic wave. Only one pair of the traces 658a and 658b is labeled in FIG. 6D for purposes of clarity. Further only one of the second traces 658b connected to the ground plane 654 is shown FIG. 6D for purposes of clarity. It should be understood that separate pairs of the traces 658a and 658b may be connected to pairs of the antennas 632 and the ground planes 654 such that the signal may be provided to the pair of traces 658a and 658b to supply the signal to the particular pair of the antennas 632 and the ground planes 654 to generate the radiated electromagnetic wave.

Referring now to FIG. 7, shown therein is a diagram of an exemplary embodiment of an interference simulation 700 constructed in accordance with the present disclosure. The interference simulation 700 illustrates simulated interference within the radiated electromagnetic wave as the radiated electromagnetic wave intersects and is reflected by the reflector 616 within the intersection 612 as the radiated electromagnetic wave travels along a path 704.

Referring now to FIG. 8, shown therein is a diagram of an exemplary embodiment of a guide system 800 constructed in accordance with the present disclosure. The guide system 800 generally comprises the originating substrate 610 coupled to a landing connector 826, described below.

The guide system 800 generally comprises a first horn 804 coupled to a second horn 808 via a first hollow waveguide 812. In one embodiment, the first hollow waveguide 812 include a first bend 816. The second horn 808 may be further coupled to a second hollow waveguide 820. In one embodiment, the first horn 804 may be coupled to the originating substrate 610, which may be implemented as an IC or PCB, for example. In one embodiment, the first horn 804 may be coupled to the originating substrate 610 via a second bend 824. In some embodiments, the first horn 804 is operable to be coupled to the originating substrate 610, and may be considered a landing connector 826. The landing connector 826 may include, for example, the second bend 824, when present.

It should be understood that the guide system 800 may include additional components and/or a different arrangement of the components shown in FIG. 8. The guide system 800 may include additional bends constructed similar to the first bend 816 and the second bend 824 as described below, e.g., as a waveguide having a curvature and a bending radius. For example, the guide system 800 may include a third bend disposed between, e.g., the first hollow waveguide 812 and the second horn 808, and/or the second horn 808 and the second hollow waveguide 820, or otherwise disposed to receive and guide a radiated electromagnetic wave within the guide system 800.

In one embodiment, the first horn 804 may comprise a landing body having a first end 830, a second end 834, and a sidewall 838 extending from the first end 830 to the second end 834. Similarly, the second horn 808 has a first end 840, a second end 844, and a sidewall 848 extending from the first end 840 to the second end 844. The first horn 804 may be considered, for example, an exemplary embodiment of the landing connector 826 having the landing body.

In one embodiment, the first hollow waveguide 812 may be a THz waveguide. For example, the first hollow waveguide 812 may be a hollow-core THz waveguide, such as an elliptical-core fiber. In some embodiments, the first hollow waveguide 812 may be constructed in accordance with the THz waveguide 218 described above in more detail. In other embodiments, the first hollow waveguide 812 may be a metallic, non-optic waveguide.

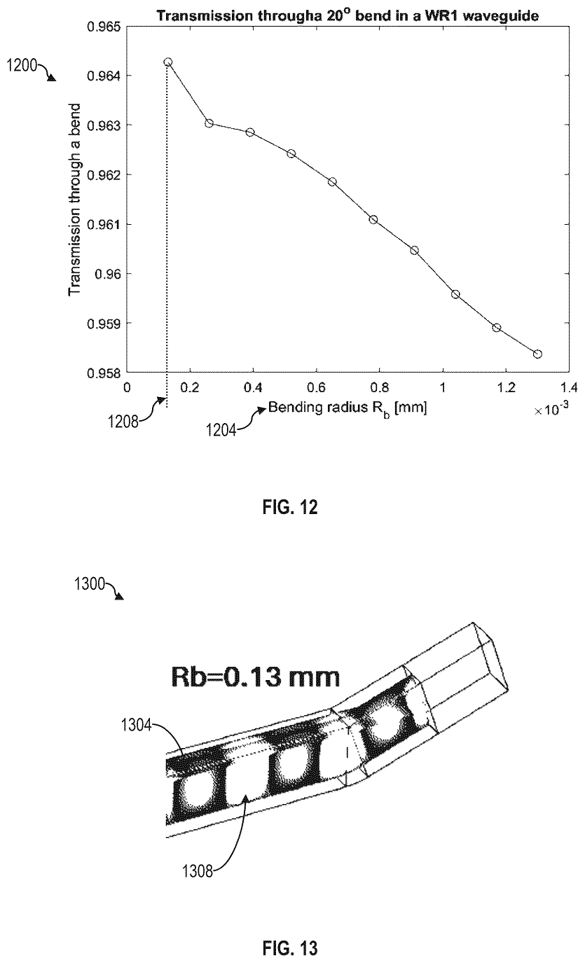

In one embodiment, the first bend 816 may be constructed as part of one or more of the first hollow waveguide 812 and the first horn 804. The first bend 816 may be part of a THz waveguide, for example, having a first curvature of between 15 and 25 degrees and a first bending radius of between 0.1 and 1.4 mm (as shown in FIG. 12, for example). The first bend 816 may be configured to guide the radiated electromagnetic wave to emerge from the first bend 816 at the angle of between 15 and 25 degrees relative to an initial propagation direction, d1. Similarly, the second bend 824 may be constructed as part of one or more of the first horn 804 and the originating substrate 610 and may be part of a THz waveguide having a second curvature complementary to the first curvature of the first bend 816. For example, the second curvature may be opposing to the first curvature such that a radiated electromagnetic wave having the initial propagation direction, d1, relative to the originating substrate 610, may continue to propagate at the second propagation direction, d2, equal to the initial propagation direction, d1. In one embodiment, the second bend 824 may have the second curvature complementary to the first curvature, but have a second bending radius different from the first bending radius.

In one embodiment, the first hollow waveguide 812 may intersect the first horn 804 at an angle of between 45 degrees and 60 degrees, for example, when the first bend 816 is omitted.

In one embodiment, the second hollow waveguide 820 may be a THz waveguide. For example, the second hollow waveguide 820 may be a hollow-core waveguide, such as an elliptical-core fiber. In some embodiments, the second hollow waveguide 820 may be constructed in accordance with the THz waveguide 218 described above in more detail. In other embodiments, the second hollow waveguide 820 may be a metallic, non-optic waveguide. The second hollow waveguide 820 may have a cross-sectional dimension aligning with the second end 844 of the second horn 808 while the first hollow waveguide 812 may have a cross-sectional dimension aligning with the first end 840 of the second horn 808.

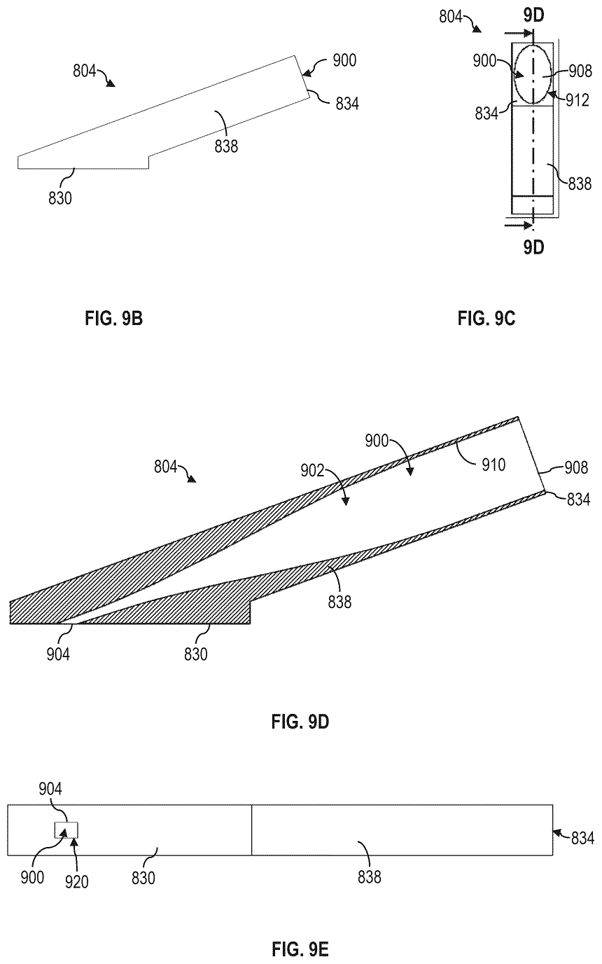

Referring now to FIGS. 9A-9E, in combination, shown therein are various views of an exemplary embodiment of the first horn 804 constructed in accordance with the present disclosure. Shown in FIG. 9A is a perspective view of the first horn 804. As shown, the first horn 804 comprises the sidewall 838 extending from the first end 830 to the second end 834 and surrounding a first hollow waveguide 900 extending from the first end 830 to the second end 834. The first hollow waveguide 900 may have a first opening 904 (FIGS. 9D and 9E) and a second opening 908 communicating with the cavity 902. Shown in FIG. 9B is a side-view of the first horn 804. Shown in FIG. 9C is a side view of the first horn 804 showing the second opening 908 of the first hollow waveguide 900.

As shown, the second opening 908 may have a second cross-sectional shape 912. The second cross-sectional shape 912 is shown as being elliptical, however, other cross-sectional shapes may be used, such as circular, or rectangular. In some embodiments, the second cross-sectional shape 912 may have a fanciful shape. In some embodiments, the second cross-sectional shape 912 may be shaped to be received by, or coupled to, the first hollow waveguide 812 and/or the first bend 816. In one embodiment, the second cross-sectional shape 912 may be shaped to form a smooth transition from the first hollow waveguide 900 to an opening of the first hollow waveguide 812, such as when the first hollow waveguide 812 is constructed as a hollow-core fiber.

In one embodiment, the first horn 804 may include, for example, a mechanical connector operable to mechanically couple the first horn 804 to one or more of the first hollow waveguide 812 and the first bend 816 and one or more of the second bend 824 and the originating substrate 610 such that the first cross-sectional shape 920 forms a transition from the second bend 824 and/or the originating substrate 610 to the first opening 904 of the first hollow waveguide 900 and the second cross-sectional shape 912 forms a transition from the second opening 908 of the first hollow waveguide 900 to the first hollow waveguide 812 and/or the first bend 816.

Shown in FIG. 9D is a cross-section view of the first horn 804 taken from the line 9D-9D and in the direction of the arrows. As shown in the FIG. 9D, the first horn 804 includes the first hollow waveguide 900 tapering from the first opening 904 towards the second opening 908 such that the opening tapers upwardly from the first opening 904 having a first cross-sectional shape 920 and a first cross-sectional dimension to the second opening 908 having the second cross-sectional shape 912 and the second cross-sectional dimension. The first horn 804 may have a geometric taper from the first opening 904 towards the second opening 908. In this way, the first opening 904 may be constructed as a single-mode waveguide while the second opening 908 may be constructed as a polarization-maintaining multi-mode waveguide.

In one embodiment, the first opening 904 may be, for example, a WR-1 (e.g., rectangular waveguide) opening operable to receive the antenna 632. The first opening 904 may also be a non-WR-1 dimensioned waveguide that allows two polarization modes to propagate. For example, the antenna 632 may be constructed to extend relative to the originating substrate 610 at an angle, similar to that of the second bend 824, on the originating substrate 610, e.g., at an angle of between 15 and 25 degrees relative to the initial propagation direction, d1. In one embodiment, the first opening 904 may have the first cross-sectional shape 920 having the first cross-sectional dimension of between about ¼ wavelength of the radiated electromagnetic wave to less than two wavelengths of the radiated electromagnetic wave.

In one embodiment, the first cross-sectional dimension of the first opening 904 may be smaller or lesser than the first cross-sectional dimension of the second opening 908. In one embodiment, such as when the guide system 800 includes the first horn 804 without the second horn 808, the second opening 908 may have the second cross-sectional shape 912 having the second cross-sectional dimension of between about two wavelengths of the radiated electromagnetic wave to less than 100 wavelengths of the radiated electromagnetic wave. In another embodiment, such as when the guide system 800 includes both the first horn 804 and the second horn 808, the second opening 908 may have the second cross-sectional shape 912 having the second cross-sectional dimension of between about two wavelengths of the radiated electromagnetic wave to less than 5 wavelengths of the radiated electromagnetic wave.

In one embodiment, the sidewall 838 of the first hollow waveguide 900 may have an interior surface 910 surrounding a cavity 902 and constructed of a conductive material. In some embodiments, the interior surface 910 is constructed of the same material as the sidewall 838 while in other embodiments, the interior surface 910 may be, for example, a conductive layer of the conductive material disposed on the sidewall 838. In this embodiment, the sidewall 838 may be constructed of a plastic material while the interior surface 910 may be constructed of a conductive material as described above. As shown in FIG. 9D, at least a portion of the interior surface 910 tapers upwardly towards the second opening 908 from the first opening 904.

Referring now to FIG. 9E, shown therein is a bottom view of the first horn 804 constructed in accordance with the present disclosure. The first horn 804 is shown with the first end 830, the second end 834, and the sidewall 838 extending from the first end 830 to the second end 834. Further shown is the first opening 904 of the first hollow waveguide 900 having the first cross-sectional shape 920.

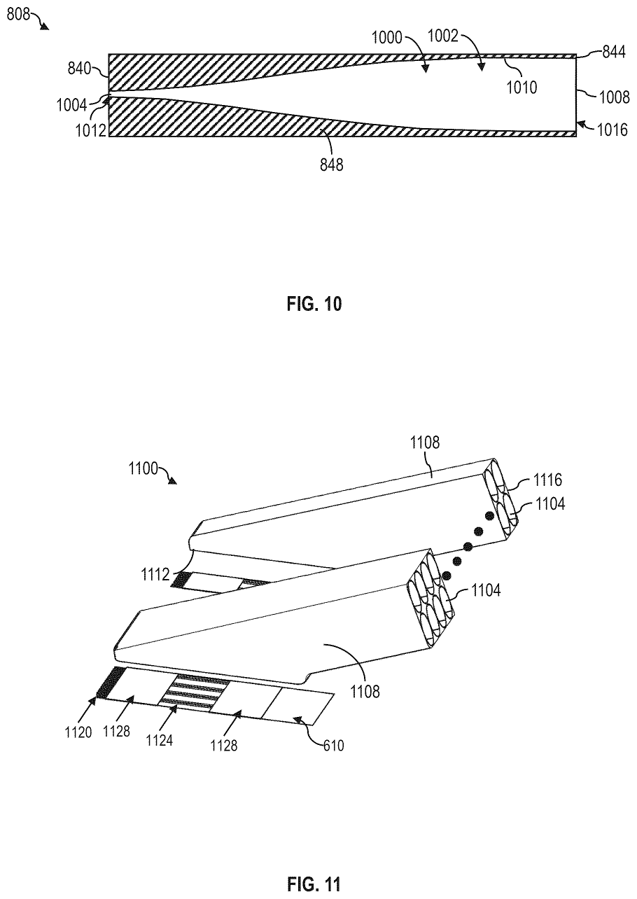

Referring now to FIG. 10, shown therein is a cross-section view of an exemplary embodiment of the second horn 808 constructed in accordance with the present disclosure. As shown, the second horn 808 has the first end 840, the second end 844, and the sidewall 848 extending from the first end 840 to the second end 844 and surrounding a second hollow waveguide 1000 extending from the first end 840 to the second end 844. The second hollow waveguide 1000 may have a second input 1004 and a second output 1008.

The second input 1004 may have a third cross-sectional shape 1012 and the second output 1008 may have a fourth cross-sectional shape 1016. Each of the third cross-sectional shape 1012 and the fourth cross-sectional shape 1016 may be, for example, elliptical, circular, or rectangular, or some fanciful shape. In some embodiments, the third cross-sectional shape 1012 may be shaped to be received by, or coupled to, the first hollow waveguide 812 and/or the first bend 816. In one embodiment, the third cross-sectional shape 1012 may be shaped to form a transition from the second hollow waveguide 1000 to an opening of the first hollow waveguide 812, such as when the first hollow waveguide 812 is constructed as a hollow-core fiber. In some embodiments, the fourth cross-sectional shape 1016 may be shaped to be received by, or coupled to, the second hollow waveguide 820. In one embodiment, the fourth cross-sectional shape 1016 may be shaped to form a transition from the second hollow waveguide 1000 to an opening of the second hollow waveguide 820, such as when the second hollow waveguide 820 is constructed as a hollow-core fiber. In one embodiment, the fourth cross-sectional shape 1016 may have a first dimension and a second dimension greater than, and orthogonal to, the first dimension.

As shown in FIG. 10, the second horn 808 includes the second hollow waveguide 1000 tapering from the second input 1004 towards the second output 1008 such that the opening tapers upwardly from the second input 1004 having the third cross-sectional shape 1012 and a third cross-sectional dimension to the second output 1008 having the fourth cross-sectional shape 1016 and a second cross-sectional dimension. In one embodiment, the second input 1004 may be constructed to be coupled to the second end 834 of the first horn 804. In one embodiment, the third cross-sectional shape 1012 may have the third cross-sectional dimension of about 5 wavelengths and the fourth cross-sectional shape 1016 may have the fourth cross-sectional dimension of less than about 100 wavelengths of the radiated electromagnetic wave.

In one embodiment, the second horn 808 may include, for example, a mechanical connector operable to mechanically couple the second horn 808 to one or more of the first hollow waveguide 812 and the second hollow waveguide 820, such that the third cross-sectional shape 1012 forms a smooth transition from the second input 1004 of the second hollow waveguide 1000 to the first hollow waveguide 812 and the fourth cross-sectional shape 1016 forms a smooth transition from the second output 1008 of the second hollow waveguide 1000 to the second hollow waveguide 820.

In one embodiment, the sidewall 848 of the second hollow waveguide 1000 may have an interior surface 1010 constructed of a conductive material. In some embodiments, the interior surface 1010 is constructed of the same material as the sidewall 848 while in other embodiments, the interior surface 1010 may be, for example, a conductive layer of the conductive material disposed on the sidewall 848. In this embodiment, the sidewall 848 may be constructed of a non-conductive material (e.g., plastic, or the like) while the interior surface 1010 may be constructed of a conductive material as described above.

Referring now to FIG. 11, shown therein is a perspective view of an exemplary embodiment of a multi-guide landing connector 1100 constructed in accordance with the present disclosure. The multi-guide landing connector 1100 may comprise a plurality of horns 1104 constructed in a single body 1108. Each of the horns 1104 may be constructed in accordance with the first horn 804, as described above in more detail. For example, a first end 1112 may be operable to couple to the originating substrate 610 and a second end 1116 may be operable to couple to a plurality of first hollow waveguides 812. In one embodiment, the originating substrate 610 may include a plurality of data lines 1120 supplying signals to a signal redistribution board 1124 (e.g., comprising traces 658), which in turn supplies the signals to chiplets 1128 having the antennae 632 disposed thereon or therein. In one embodiment, when the multi-guide landing connector 1100 is positioned or coupled to the originating substrate 610, antennae 632 disposed on or within the originating substrate 610 may not extend within the multi-guide landing connector 1100. For example, the multi-guide landing connector 1100 may be butt-coupled to the originating substrate 610.

In one embodiment, the multi-guide landing connector 1100 may be operable to be coupled to the first hollow waveguide 812 constructed in accordance with one or more of the THz waveguides 208 such that each of the horns 1104 of the multi-guide landing connector 1100 aligns with a particular air channel of the THz waveguide 208.

Referring now to FIG. 12, shown therein is a graph of an exemplary embodiment of a simulated transmission percent 1200 (e.g., ratio of total transmission power through compared to total radiated power) through a 20-degree bend in a hollow waveguide (such as in the first bend 816 and the second bend 824) at varying bending radii 1204. As shown, as the bending radius 1208 increases, the simulated transmission percent 1200 through the bend decreases. A performance simulation 1300 is shown in FIG. 13, is discussed below in relation to a particular bending radius 1208 of 0.13 mm.

Referring now to FIG. 13, shown therein is a diagram of an exemplary embodiment of the performance simulation 1300 constructed in accordance with the present disclosure. The performance simulation 1300 illustrates simulated strength of the radiated electromagnetic wave as the radiated electromagnetic wave travels through the 20-degree bend, of FIG. 12, having the particular bending radius 1208 of 0.13 mm. The particular bending radius 1208 may be, for example, a bending radius of one or more of the first bend 816 and the second bend 824. As shown, the performance simulation 1300 illustrates alternating regions where the radiated electromagnetic wave is strongly negative (region 1304) and regions where the radiated electromagnetic wave is strongly positive (region 1308). In some embodiments, the particular bending radius 1208 may include one or more of the first bend 816 and the second bend 824 and additional bends implemented in the guide system 800.

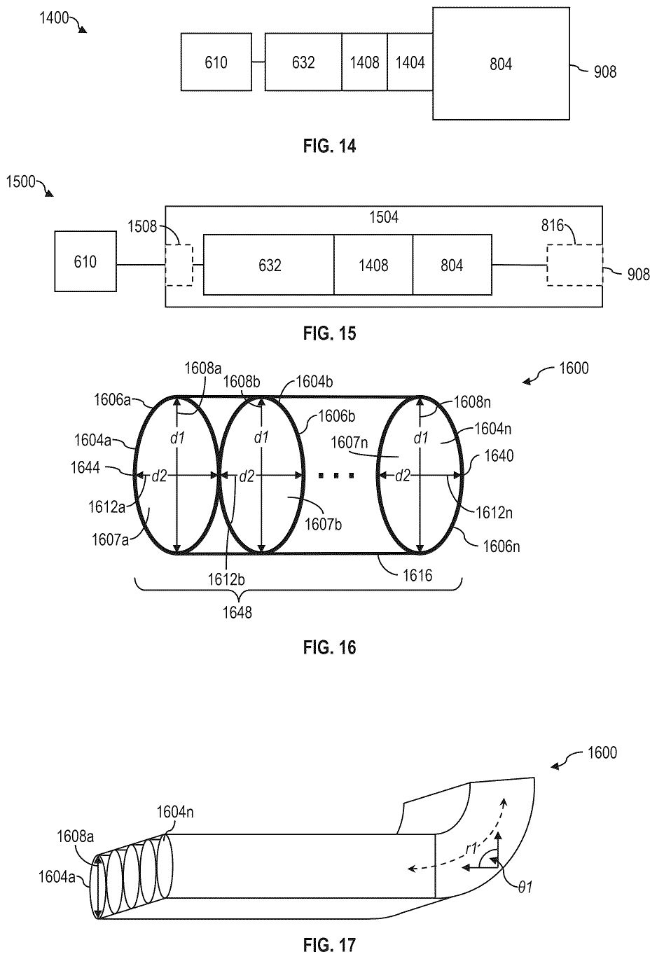

Referring now to FIG. 14, shown therein is a block diagram of an exemplary embodiment of a second guide system 1400 constructed in accordance with the present disclosure. As shown, the second guide system 1400 may comprise the originating substrate 610, such as a chip, chiplet, IC, or PCB, communicably coupled with the antenna 632. The second guide system 1400 may further comprise a first bend 1404 coupled to the antenna 632, such as by a rectangular waveguide 1408. The second guide system 1400 may further comprise the first horn 804 coupled to the first bend 1404 to receive the radiated electromagnetic wave (e.g., an electromagnetic wave having a frequency in a range between 300 GHz and 10 THz). In some embodiments, the first horn 804 may further include a second bend having a complementary angle/curvature, while in other embodiments, the first horn 804 may omit the second bend.

Referring now to FIG. 15, shown therein is a block diagram of an exemplary embodiment of a third guide system 1500 constructed in accordance with the present disclosure. As shown, the third guide system 1500 may comprise the originating substrate 610, such as a chip, chiplet, IC, or PCB, communicably coupled with a landing connector 1504. The landing connector 1504 may comprise the antenna 632 coupled to the rectangular waveguide 1408 coupled to the first horn 804. The landing connector 1504 may, in some embodiments, further include the first bend 816. The landing connector 1504 may further include the second opening 908 having the second cross-sectional shape 912.

The first horn 804 of the third guide system 1500 may receive the radiated electromagnetic wave (e.g., an electromagnetic wave having a frequency in a range between 300 GHz and 10 THz) from the rectangular waveguide 1408. In some embodiments, the first horn 804 may further include the first bend 816 having a complementary angle/curvature to an angle between the antenna 632 and the rectangular waveguide 1408, while in other embodiments, the first horn 804 may omit the first bend 816.

In one embodiment, the landing connector 1504 of the third guide system 1500 may further comprise a series of exposed contacts 1508 configured to connect to the originating substrate 610 such as to an IC or a distribution board.

Referring now to FIG. 16, shown therein is a cross-sectional view of an exemplary embodiment of a first fiber array 1600 constructed in accordance with the present disclosure. As shown the first fiber array 1600 includes a transverse cross-sectional shape comprising a plurality of hollow waveguides 1604a-n extending longitudinally along the length of the first fiber array. The first fiber array 1600 has a plurality of sidewalls 1606a-n connected together, and extending longitudinally along the length of the fiber array 1600 with each respective sidewall 1606a-n surrounding a hollow core 1607a-n with the hollow cores 1607a-n each having parallel major axes 1608a-n with a major dimension, d1, and minor axes 1612a-n with a minor dimension, d2 along the transverse cross-sectional shape. The hollow cores 1607a-n may be filled with a gas. For example, as shown, the first fiber array 1600 may comprise a first hollow waveguide 1604a having a first sidewall 1606a surrounding the first hollow core 1607a having a first major axis 1608a and a first minor axis 1612a and a second hollow waveguide 1604b having a second sidewall 1606b surrounding the second hollow core 1607b having a second major axis 1608b and a second minor axis 1612b. In this way, each hollow core 1607 of the hollow waveguide 1604 of the plurality of hollow waveguides 1604a-n may be a polarization maintaining fiber for radiated electromagnetic waves having a frequency in a range between 300 GHz and 10 THz. The radiated electromagnetic wave may be a linear-polarized wave such as a radiated electromagnetic wave having one of a TE10 or an HE11 mode.

The plurality of hollow waveguides 1604 of the first fiber array 1600 may be formed in a cable body 1616 such that the minor axes 1612 of the hollow core 1607 of the hollow waveguides 1604 are substantially coplanar. In other embodiments, such as shown in FIG. 19, the major axes 1608 may be substantially coplanar.

In one embodiment, for each hollow core 1607 of the hollow waveguide 1604 of the plurality of hollow waveguides 1604, the major axes 1608 may be orthogonal to, or substantially orthogonal to, the minor axes 1612. For example, the major axis 1608a may be orthogonal to, or substantially orthogonal to, the first minor axis 1612a. In this way, each hollow waveguide 1604 may be a polarization maintaining multi-mode waveguide. In one embodiment, each of the hollow waveguides 1604 of the first fiber array 1600 may be a hollow-core THz waveguide, such as an elliptical-core fiber. Each of the hollow cores 1607 may have a uniform cross-sectional area.

It should be understood that the first fiber array 1600 may comprise any number of hollow waveguides 1604 and is not limited to the number of hollow waveguides 1604 shown in FIG. 16. Further, in some embodiments, the first fiber array 1600 may include more than a single row of hollow waveguides 1604. For example, the first fiber array 1600 may comprise a first row of hollow waveguides 1604 having coplanar minor axes 1612 and a second row of hollow waveguides having coplanar minor axes 1612 aligned such that the major axes 1608 of the hollow waveguides 1604 of the second row are aligned with the major axes 1608 of the hollow waveguides 1604 of the first row. Additionally, in some embodiments, the first fiber array 1600 may comprise more than two rows of hollow waveguides 1604.

In one embodiment, the cable body 1616 of the first fiber array 1600 may have a first side 1640, a second side 1644 opposite the first side 1640, and a width 1648 extending between the first side and the second side. The minor axes 1612 of the hollow waveguides 1604 may extend parallel to the width 1648 of the cable body 1616. When more than one row of hollow waveguides 1604 are present, the minor axes 1612 of the hollow waveguides 1604 of the first row and the minor axes 1612 of the hollow waveguides 1604 of the second row may extend parallel to the width 1648 of the cable body 1616.

In one embodiment, the first fiber array 1600 may be constructed such that the first fiber array 1600 is configured to be optically coupled to the landing connector, such as the multi-guide landing connector 1100 shown in FIG. 11. For example, each of the plurality of horns 1104 of the multi-guide landing connector 1100 may align to each of the hollow waveguides 1604 of the first fiber array 1600 such that the radiated electromagnetic waves can be introduced into the hollow cores 1607.

In one embodiment, each of the hollow waveguides 1604 may be constructed in accordance with the fourth THz waveguide 208d (i.e., each of the hollow waveguides 1604 may include an optional reflective layer), with the exception that the plurality of hollow waveguides 1604a-n are disposed adjacent to one another and supported by the cable body 1616. While the cable body 1616 is shown as forming a flat surface in FIG. 16, it should be understood that in other embodiments, the cable body 1616 may contour to the plurality of hollow waveguides 1604 to position and support the plurality of hollow waveguides 1604. In some embodiments, the cable body 1616 may be constructed, for example, having a protective layer.

Referring now to FIG. 17, shown therein is a perspective view of an exemplary embodiment of the first fiber array 1600 of FIG. 16, constructed in accordance with the present disclosure. The first fiber array 1600 may have flexibility along a particular axis of either the major axis 1608 or the minor axis 1612. The first fiber array 1600 in FIG. 17 is shown being flexible along the major axis 1608 of the hollow waveguides 1604. The first fiber array 1600 may be constructed such that the cable body 1616 may accommodate a range of bending radii, r1, of the first fiber array 1600 across the major axes 1608. For example, the bending radius, r1, may be 4 cm, between about 1 cm and about 8 cm, or greater than 1 cm. In this way, the first fiber array 1600 may have a major angle, θ1, across the major axes 1608 based on a length of the first fiber array 1600 having the bending radius, r1.

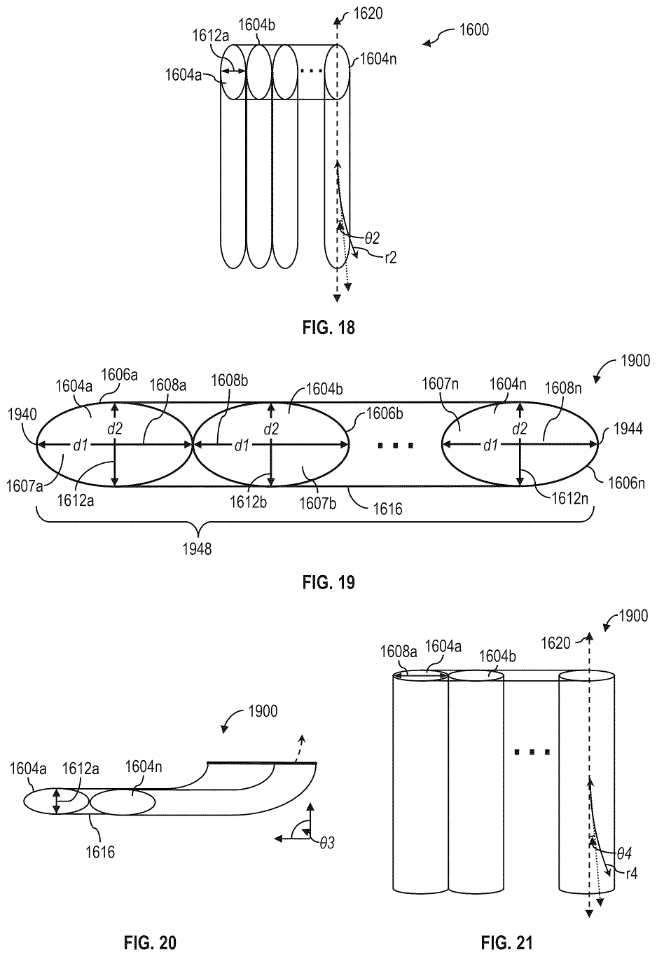

Referring now to FIG. 18, shown therein is a top-view of an exemplary embodiment of a portion of the first fiber array 1600 constructed in accordance with the present disclosure. As shown in FIG. 18, the first fiber array 1600 may be constructed such that the first fiber array 1600 has limited flexion across the minor axes 1612 of the plurality of hollow waveguides 1604a-n along a longitudinal axis 1620. The first fiber array 1600 may be constructed such that the cable body 1616 may accommodate a range of bending radii, r2, of the first fiber array 1600 across the minor axes 1612. For example, the bending radius, r2, may be 15 cm, between about 5 cm and about 30 cm, or greater than 5 cm. In this way, the first fiber array 1600 may have a minor angle, θ2, across the minor axes 1612 based on a length of the first fiber array 1600 having the bending radius, r2.

Referring now to FIG. 19, shown therein is a cross-sectional view of an exemplary embodiment of a second fiber array 1900 constructed in accordance with the present disclosure. As shown the second fiber array 1900 may be constructed in accordance with the first fiber array 1600, shown in FIG. 16, with the exception of the plurality of hollow waveguides 1604a-n being disposed adjacent one another and having parallel minor axes 1612 with the minor dimension, d2, and aligned major axes 1608 with the major dimension, d1. For example, as shown, the second fiber array 1900 may comprise the first hollow waveguide 1604a having the first sidewall 1606a surrounding the first hollow core 1607a having the first major axis 1608a and the first minor axis 1612a and the second hollow waveguide 1604b having the second major axis 1608b and the second minor axis 1612b. The plurality of hollow waveguides 1604 of the second fiber array 1900 may be formed in a cable body 1616 such that the major axes 1608 of the hollow waveguides 1604 are substantially coplanar.

It should be understood that the second fiber array 1900 may comprise any number of hollow waveguides 1604 and is not limited to the number of hollow waveguides 1604 shown in FIG. 19. Further, in some embodiments, the second fiber array 1900 may include more than a single row of hollow waveguides 1604. For example, the second fiber array 1900 may comprise a first row of hollow waveguides 1604 having coplanar major axes 1608 and a second row of hollow waveguides 1604 having coplanar major axes 1608, where the first row and the second row are disposed adjacent each other and aligned such that the minor axes 1612 of the hollow waveguides 1604 of the second row are aligned with the minor axes 1612 of the hollow waveguides 1604 of the first row. Additionally, in some embodiments, the second fiber array 1900 may comprise more than two rows of hollow waveguides 1604.

In one embodiment, the cable body 1616 of the second fiber array 1900 may have a first side 1940, a second side 1944 opposite the first side 1940, and a width 1948 extending between the first side 1940 and the second side 1944. The major axes 1608 of the hollow waveguides 1604 may extend parallel to the width 1948 of the cable body 1616. When more than one row of hollow waveguides 1604 are present, the major axes 1608 of the hollow waveguides 1604 of the first row and the major axes 1608 of the hollow waveguides 1604 of the second row may extend parallel to the width 1948 of the cable body 1616.

In one embodiment, the second fiber array 1900 may be constructed such that the second fiber array 1900 is configured to be optically coupled to the landing connector, such as the multi-guide landing connector 1100 shown in FIG. 11. For example, each of the plurality of horns 1104 of the multi-guide landing connector 1100 may align to each of the hollow waveguides 1604 of the second fiber array 1900.

Referring now to FIG. 20, shown therein is a perspective view of an exemplary embodiment of the second fiber array 1900 of FIG. 19, constructed in accordance with the present disclosure. The second fiber array 1900 may have flexibility along a particular axis of either the major axis 1608 or the minor axis 1612. The second fiber array 1900 in FIG. 20 is shown being flexible along the minor axis 1612 of the hollow waveguides 1604. The second fiber array 1900 may be constructed such that the cable body 1616 may accommodate a range of bending radii, r3, of the second fiber array 1900 across the minor axes 1612. For example, the bending radius, r3, may be 4 cm or between about 2 cm and about 6 cm. In this way, the second fiber array 1900 may have a minor angle, θ3, across the minor axes 1612 based on a length of the second fiber array 1900 having the bending radius, r3.

Referring now to FIG. 21, shown therein is a top-view of an exemplary embodiment of a portion of the second fiber array 1900 constructed in accordance with the present disclosure. As shown in FIG. 21, the second fiber array 1900 may be constructed such that the second fiber array 1900 has limited flexion across the major axes 1608 of the plurality of hollow waveguides 1604a-n along the longitudinal axis 1620. The second fiber array 1900 may be constructed such that the cable body 1616 may accommodate a range of bending radii, r4, of the second fiber array 1900 across the major axes 1608. For example, the bending radius, r4, may be 15 cm or between about 10 cm and 20 cm. In this way, the second fiber array 1900 may have a major angle, θ4, across the major axes 1608 based on a length of the second fiber array 1900 having the bending radius, r4.

The first fiber array 1600 and/or the second fiber array 1900 may be constructed by any suitable process, such as an extrusion process or 3D printing. The extrusion process can be used to make the first fiber array 1600 and/or the second fiber array 1900 from glass, plastic, or other materials. In this process, billets are heated to above their transition temperature (melting temperature), and then pushed through an appropriately shaped die in a liquid state using high pressure in order to acquire the desired transverse cross-sectional shape having the plurality of sidewalls 1606a-n connected together and extending longitudinally along the length of the fiber array 1600 or 1900 with each respective sidewall 1606a-n surrounding the hollow core 1607a-n. In some embodiments, the extrusion process may be a co-extrusion process in which a core material, a metallic inner coating, and a cladding material are fed through the die simultaneously such that the sidewalls 1606 are constructed of the core material, coated with the metallic material, and surrounded by the cladding material.

In another embodiment, the first fiber array 1600 and/or the second fiber array 1900 are formed through three-dimensional (3D) printing.

A first type of 3D printing uses a filament of material which is pushed through a nozzle in order to “write” a first layer of the desired object onto a substrate, which relatively moves in a plane perpendicular to the nozzle to trace the desired shape. The substrate is then shifted further away from the nozzle (or the nozzle is shifted further away from the substrate) and the process is repeated in order to build up the first fiber array 1600 or the second fiber array 1900 layer by layer.

A second type of 3D printing uses a bed of dust of the required material for the first fiber array 1600 or the second fiber array 1900 to be printed. A first layer of the object is formed by applying a laser beam to the dust in order to sinter it. Then a further layer of dust is provided which is sintered in turn, in order to build up the first fiber array 1600 or the second fiber array 1900 layer by layer.

The materials used in 3D printing include, but are not limited to, plastics, metals, and ceramics.

The shaped first fiber array 1600 or the second fiber array 1900 and an outer jacket tube may be made from any of the materials known for the fabrication of existing designs of antiresonant hollow core fiber, including glass materials such as silica, and polymer materials. The various shaped first fiber array 1600 or the second fiber array 1900 and the outer jacket tube in a single preform or fiber may be made from the same material or from different materials. Types of glass include “silicate glasses” or “silica-based glasses”, based on the chemical compound silica (silicon dioxide, or quartz), of which there are many examples. Other glasses suitable for passing the radiated electromagnetic signals include, but are not limited to, chalcogenides, tellurite glasses, fluoride glasses, and doped silica glasses. The materials may include one or more dopants for the purpose of tailoring the properties conducive to propagating the radiated electromagnetic wave.

Fiber drawing techniques for making hollow core fibers include the application of one or more pressures to the interiors of the hollow cores 1607a-n within a preform during drawing, in order to control and tailor the cross-sectional size and shape of the hollow cores 1607a-n defined by the sidewalls 1606a-n can be used. These fiber drawing techniques can be used in the present case in order to define the size and shape of the hollow cores 1607a-n to promote propagation of the radiated electromagnetic waves. Preferably, the dimensions of the sidewalls 1606a-n are provided such that the dimensions of the hollow cores 1607a-n are uniform along the transverse cross-sectional shape. Further the dimension of each sidewall 1606a-n is preferably uniform along its longitudinal axis, i.e., along the length of the sidewalls 1606a-n.

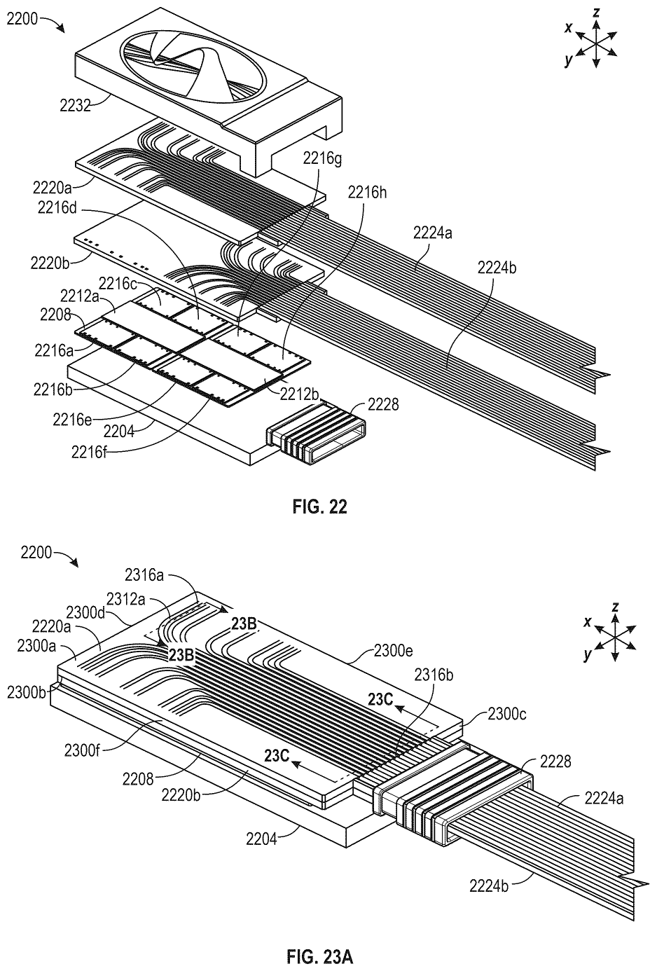

Referring now to FIG. 22, shown therein is an exploded isometric view of an exemplary embodiment of a THz interposer assembly 2200 constructed in accordance with the present disclosure.

As shown in FIG. 22, the THz interposer assembly 2200 may comprise a PCB 2204, a GHz interposer 2208, one or more ASICs 2212a-n (hereinafter the “ASICs 2212” or each individually an “ASIC 2212”)—such as a first ASIC 2212a and a second ASIC 2212b shown in FIG. 22—and one or more THz transceivers 2216a-n (hereinafter the “THz transceivers 2216” or each individually a “THz transceiver 2216”)—such as a first THz transceiver 2216a, a second THz transceiver 2216b, a third THz transceiver 2216c, a fourth THz transceiver 2216d, a fifth THz transceiver 2216e, a sixth THz transceiver 2216f, a seventh THz transceiver 2216g, and an eighth THz transceiver 2216h shown in FIG. 22—mounted on the GHz interposer 2208, one or more THz interposers 2220a-n (hereinafter the “THz interposers 2220” or each individually a “THz interposer 2220”)—such as a first THz interposer 2220a and a second THz interposer 2220b shown in FIG. 22—one or more THz waveguide arrays 2224a-n (hereinafter the “THz waveguide arrays 2224” or each individually a “THz waveguide array 2224”), each of the THz waveguide arrays 2224 corresponding to a respective one of the THz interposers 2220—such as a first THz waveguide array 2224a corresponding to the first THz interposer 2220a and a second THz waveguide array 2224b corresponding to the second THz interposer 2220b—a Waveguide Array Connector (WAC) 2228, and a cover 2232. Each of the one or more THz interposers 2220 may be a planar element substantially in the form of a cuboid having six rectangular faces, eight vertices, and twelve edges where all angles are right angles. The THz interposer 2220 has a length, width and height. In some examples, the height of the THz interposer 2220 may be in a range between 1% and 40% of the width of the THz interposer 2220 and/or the height of the THz interposer 2220 being in a range between 0.3% and 20% of the length of the THz interposer 2220.

In the embodiment shown in FIG. 22, the first THz transceiver 2216a, the second THz transceiver 2216b, the third THz transceiver 2216c, and the fourth THz transceiver 2216d correspond to the first ASIC 2212a and are coupled thereto via the GHz interposer 2208, while the fifth THz transceiver 2216e, the sixth THz transceiver 2216f, the seventh THz transceiver 2216g, and the eighth THz transceiver 2216h correspond to the second ASIC 2212b and are coupled thereto via the GHz interposer 2208.

While the THz interposer assembly 2200 is shown in FIG. 22 as comprising two of the THz interposers 2220, it should be understood that, as described in more detail below, other embodiments of the THz interposer assembly 2200 may comprise a number of the THz interposers 2220 that is greater or fewer than two. Further, while the THz interposer assembly 2200 is shown in FIG. 22 as comprising the PCB 2204, the GHz interposer 2208, the ASICs 2212, the THz transceivers 2216, and the THz interposers 2220, it should be understood that the THz interposer assembly 2200 as described herein may lack one or more of such components. For example, in one exemplary embodiment, the THz interposer assembly 2200 may simply comprise the THz interposers 2220.

In an outbound direction, the PCB 2204 may be configured to receive outbound electrical signals from a local signal source and convey the outbound electrical signals through the GHz interposer 2208 to at least one of the ASICs 2212.

Each of the ASICs 2212 may be configured to receive outbound electrical signals from the PCB 2204 via the GHz interposer 2208, perform signal conditioning and manipulation on the outbound electrical signals to generate outbound baseband signals based on the outbound electrical signals, and provide the outbound baseband signals to at least one of the THz transceivers 2216.

In some embodiments, at least one of the ASICs 2212 may be coupled directly to the PCB 2204 rather than being coupled to the PCB 2204 via the GHz interposer 2208.

The GHz interposer 2208 may comprise a low-k dielectric material, such as benzocyclobutene (BCB), to minimize signal loss for the outbound electrical signals prior to up-conversion. A thicker dielectric layer (e.g., greater than 9 μm) within the GHz interposer 2208 may be utilized to further reduce capacitive coupling and improve signal integrity.

In some embodiments, at least one of the ASICs 2212 may be a Complementary Metal-Oxide-Semiconductor (CMOS) chip, for example. The signal conditioning and manipulation of the outbound electrical signals by the ASICs 2212 may include equalization, initial amplification, or retiming, for example.

Each of the THz transceivers 2216 may be configured to receive the outbound baseband signals from at least one of the ASICs 2212 via the GHz interposer 2208, perform final amplification on the outbound baseband signals, and generate antenna feed signals based on the outbound baseband signals by up-converting the outbound baseband signals (i.e., modulating the outbound baseband signals onto carrier signals having frequencies in the THz frequency band 104).

Each of the THz transceivers 2216 may comprise a substrate-integrated antenna—of the transmitter antenna array 520, for example—operable to transmit outbound THz signals based on the antenna feed signals into at least one of the THz interposers 2220—or, in some embodiments, a substrate-integrated waveguide which may convey the outbound THz signals to at least one of the THz interposers 2220. In some embodiments, at least one of the THz transceivers 2216 may be an Indium Phosphide (InP) chip, for example. In some embodiments, the substrate-integrated antenna of at least one of the THz transceivers 2216 may be a slot antenna.

The THz interposers 2220 of the THz interposer assembly 2200 may be configured to be stackable to achieve higher bandwidth. In some embodiments, each of the THz interposers 2220 may support eight transmit channels and eight receive channels, for example, providing a 1.6 terabits per second (Tbps) increment for each of the THz interposers 2220 added to the stack (i.e., the THz interposer assembly 2200).

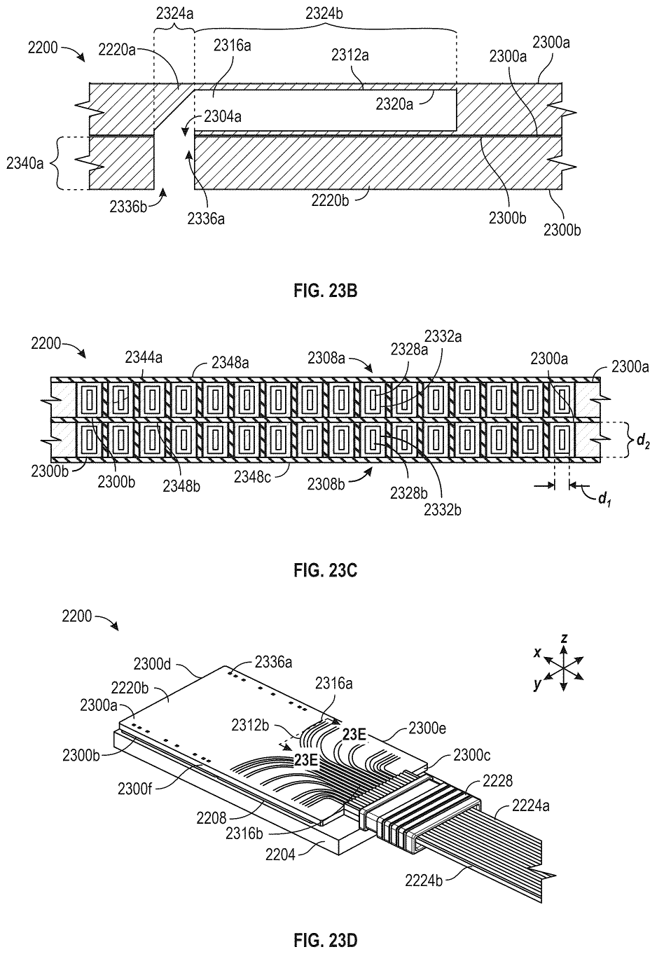

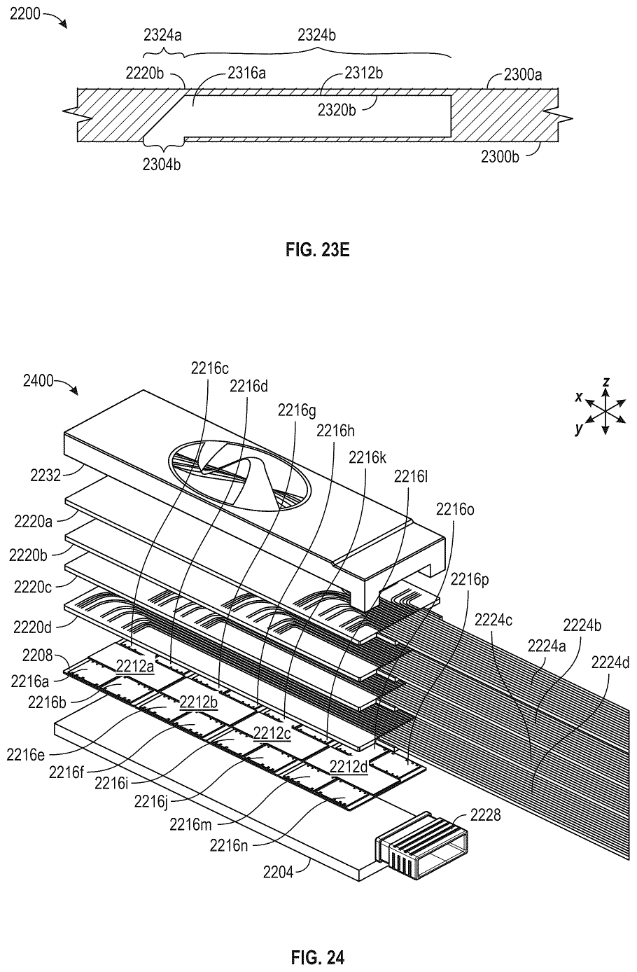

The WAC 2228 may be configured to serve as a housing around the THz waveguide arrays 2224 as they enter and exit the THz interposer assembly 2200. The WAC 2228 may be further configured to facilitate a connection, such as a butt coupling or an evanescent coupling, between the THz waveguides 2312 (shown in FIG. 23) within the THz interposers 2220 and the THz waveguide arrays 2224 external to the THz interposers 2220. In some embodiments, this connection may be achieved using fiber ferrules, such as in a 1×16 array or a 2×8 stacked array. As described in more detail below, a plurality of THz waveguides 2312a-n (shown in FIG. 23) of the THz interposers 2220 and/or individual THz waveguides of the THz waveguide arrays 2224 may be set in V-grooves or a silicon grid to define spacing.

As described in more detail below, each of the THz interposers 2220 may be generally configured to receive THz signals from a first signal structure (e.g., antenna, antenna array, evanescent coupler such as a coplanar stripline, or THz waveguide) disposed outside of the THz interposer 2220 and transmit the THz signals to a second signal structure (e.g., antenna, antenna array, evanescent coupler such as a coplanar stripline, or THz waveguide) disposed outside of the THz interposer 2220. For example, in some embodiments, the THz interposer 2220 may be configured to receive the outbound THz signals from at least one of the THz transceivers 2216 and convey the outbound THz signals to at least one of the THz waveguide arrays 2224.

Each of the THz waveguide arrays 2224 may be configured to receive the outbound THz signals from at least one of the THz interposers 2220 and convey the outbound THz signals to a remote signal destination. In an inbound direction, each of the THz waveguide arrays 2224 may be further configured to receive inbound THz signals from a remote signal source and convey the inbound THz signals to at least one of the THz interposers 2220. As described in more detail below, each of the THz interposers 2220 may be further configured to receive the inbound THz signals from at least one of the THz waveguide arrays 2224 and convey the inbound THz signals to at least one of the THz transceivers 2216.

Each of the THz transceivers 2216 may be further operable to, using the substrate-integrated antenna (e.g., of the receiver antenna array 524), detect the inbound THz signals received from at least one of the THz interposers 2220—or, in some embodiments, a substrate-integrated waveguide, which may convey the inbound THz signals from at least one of the THz interposers 2220—and generate antenna output signals based on the inbound THz signals.

Each of the THz transceivers 2216 may be further configured to perform low-noise amplification on the antenna output signals and generate inbound baseband signals based on the antenna output signals by down-converting the antenna output signals (i.e., demodulating the antenna output signals from the carrier signals having frequencies in the THz frequency band 104).

Each of the ASICs 2212 may be further configured to receive the inbound baseband signals from at least one of the THz transceivers 2216 via the GHz interposer 2208, perform signal conditioning and manipulation on the inbound baseband signals to generate inbound electrical signals based on the inbound baseband signal, and provide the inbound electrical signals to the PCB 2204 via the GHz interposer 2208. The signal conditioning and manipulation of the inbound baseband signals by the ASICs 2212 may include equalization, amplification, or retiming, for example.

The PCB 2204 may be further configured to receive the inbound electrical signals from at least one of the ASICs 2212 via the GHz interposer 2208 and convey the inbound electrical signals to a local signal destination.

Each of the signal structures, such as the local signal source, the remote signal destination, the remote signal source, and the local signal destination, may be a networking device (e.g., a router or a network switch card) or a processor (e.g., a GPU), for example.

Referring now to FIGS. 23A-23E, shown therein are: an isometric view of the THz interposer assembly 2200 shown in FIG. 22, wherein the cover 2232 has been removed such that the first THz interposer 2220a may be seen (FIG. 23A); a cross-sectional view of the THz interposer assembly 2200 shown in FIG. 23A, taken from the line 23B-23B and in the direction of the arrows (FIG. 23B); another cross-sectional view of the THz interposer assembly 2200 shown in FIG. 23A, taken from the line 23C-23C and in the direction of the arrows (FIG. 23C); another isometric view of the THz interposer assembly 2200 shown in FIG. 22, wherein the cover 2232 and the first THz interposer 2220a have been removed such that the second THz interposer 2220b may be seen (FIG. 23D); and a cross-sectional view of the THz interposer assembly 2200 shown in FIG. 23D, taken from the line 23E-23E and in the direction of the arrows.

As shown in FIGS. 23A-23E, the first THz interposer 2220a and the second THz interposer 2220b—and, in other embodiments, any of the THz interposers 2220—may have a plurality of exterior surfaces 2300a-n (hereinafter the “exterior surfaces 2300” or each individually an “exterior surface 2300”), such as an upper exterior surface 2300a, a lower exterior surface 2300b opposite the upper exterior surface 2300a, a proximal exterior surface 2300c, a distal exterior surface 2300d opposite the proximal exterior surface 2300c, a first lateral exterior surface 2300e, and a second lateral exterior surface 2300f opposite the first lateral exterior surface 2300e.

For purposes of illustration, an x axis may extend along the upper exterior surface 2300a and the lower exterior surface 2300b of the THz interposers 2220 in a direction from the proximal exterior surface 2300c toward the distal exterior surface 2300d; a y axis may extend along the upper exterior surface 2300a and the lower exterior surface 2300b of the THz interposers 2220 in a direction from the first lateral exterior surface 2300e toward the second lateral exterior surface 2300f; and a z axis may extend along the proximal exterior surface 2300c, the distal exterior surface 2300d, the first lateral exterior surface 2300e, and the second lateral exterior surface 2300f of the THz interposers 2220 in a direction from the lower exterior surface 2300b toward the upper exterior surface 2300a.

While the first THz interposer 2220a and the second THz interposer 2220b are shown in FIGS. 23A-23E as being generally cuboid in shape, it should be understood that, in other embodiments, at least one of the THz interposers 2220 may be otherwise polyhedron in shape. Further, in other embodiments, at least one of the THz interposers 2220 may have an irregular or fanciful shape.

One or more of the exterior surfaces 2300 of each of the THz interposers 2220 may define a plurality of first ports 2304a-n (hereinafter the “first ports 2304”)—such as first port 2304a shown in FIG. 23B and first port 2304b shown in FIG. 23E—and a plurality of second ports 2308a-n (hereinafter the “second ports 2308”)—such as second port 2308a and second port 2308b shown in FIG. 23C. For purposes of clarity, only two of the second ports 2308 are labeled with reference characters.

In the embodiment shown in FIGS. 23A-23E, each of the first ports 2304 and the second ports 2308 are implemented as apertures. However, in other embodiments, at least one or both of the first ports 2304 and the second ports 2308 may include an evanescent coupler, such as a coplanar stripline (CPS) coupling structure and/or an evanescent coupling region in which THz signals from a first THz waveguide are coupled into a second THz waveguide, for example. The first ports 2304 and the second ports 2308 are configured to couple the THz signal into or out of a respective THz waveguide.

In embodiments wherein one or more of the first ports 2304 and second ports 2308 are implemented as apertures, the apertures may comprise a window formed in a conductive layer (e.g., the conductive layers 2348 (shown in FIG. 23C)). The dimensions of the window may be tuned to the operating frequency. In one exemplary embodiment, the window may have a first dimension in a range between 50 μm and 400 μm and a second dimension in a range between 75 μm and 400 μm to improve coupling efficiency.

In the embodiment shown in FIGS. 23A-23E, which may be referred to as a “side launch” embodiment, the lower exterior surface 2300b of each of the THz interposers 2220 defines the first ports 2304, and the proximal exterior surface 2300c of each of the THz interposers 2220 defines the second ports 2308. However, it should be understood that other ones of the exterior surfaces 2300 may define one or more of the first ports 2304 and/or one or more of the second ports 2308. For example, in certain embodiments, which may be referred to as “top launch” embodiments having a stacked THz waveguide configuration shown in FIGS. 29A and 29B, the lower exterior surface 2300b of each of the THz interposers 2220 defines the first ports 2304, and the upper exterior surface 2300a of each of the THz interposers 2220 defines the second ports 2308. Further, in other embodiments, the same one of the exterior surfaces 2300 may define one or more of the first ports 2304 and/or one or more of the second ports 2308. For example, in certain embodiments, the upper exterior surface 2300a of each of the THz interposer defines the first ports 2304 and the second ports 2308.

The THz interposers 2220 may be further configured to function as a heat sink to transfer heat from the ASICs 2212, the THz transceivers 2216, and/or other components below (i.e., closer in proximity to the PCB 2204).

As described in more detail below, at least one of the first ports 2304 and/or at least one of the second ports 2308 may be configured to couple to one of a substrate-integrated antenna and a substrate-integrated waveguide.

Each of the THz interposers 2220 may further comprise one or more THz waveguides 2312a-n (hereinafter the “THz waveguides 2312” or each individually a “THz waveguide 2312”)—such as a first THz waveguide 2312a shown in FIG. 23A and a second THz waveguide 2312b shown in FIG. 23D—disposed or embedded therein. Each of the THz waveguides 2312 may extend between a first waveguide end 2316a coupled to a respective one of the first ports 2304 and a second waveguide end 2316b opposite the first waveguide end 2316a and coupled to a respective one of the second ports 2308. For example, in the embodiment shown in FIGS. 23A-23E, a first THz waveguide 2312a extends between the first waveguide end 2316a coupled to the first port 2304a and the second waveguide end 2316b coupled to the second port 2308a, and a second THz waveguide 2312b extends between the first waveguide end 2316a coupled to the first port 2304b and the second waveguide end 2316b coupled to the second port 2308b.

At least a portion of at least one of the THz waveguides 2312 may comprise a dielectric material configured for low loss (i.e., having a propagation loss in a range between 0.001 dB per cm and 1.0 dB per cm) in the THz frequency band 104. At least one of the THz waveguides 2312 may be configured to propagate THz signals having a frequency in the THz frequency band 104 with a propagation loss in the range between 0.001 dB per cm and 1.0 dB per cm.

While the embodiment shown in FIGS. 23A-23E has sixteen of each of the first ports 2304, the second ports 2308, and the THz waveguides 2312, it should be understood that at least one of the THz interposers 2220 may have a number of each of the first ports 2304, the second ports 2308, and the THz waveguides 2312 that is greater or fewer than sixteen.

Each of the THz interposers 2220 may have a plurality of interior surfaces 2320a-n (hereinafter the “interior surfaces 2320”)—such as a first interior surface 2320a of the first THz interposer 2220a shown in FIG. 23B and a second interior surface 2320b of the second THz interposer 2220b shown in FIG. 23E. In some embodiments, each of the THz waveguides 2312 of each of the THz interposers 2220 comprise a waveguide channel defined by the interior surfaces 2320 of such THz interposer 2220. That is, the interior surfaces 2320 of the THz interposers 2220 may define limits of each of the THz waveguides 2312. In some such embodiments, the THz interposers 2220 comprise the dielectric material, and in other such embodiments, the THz waveguides 2312 comprise a first dielectric material and the THz interposers 2220 comprise a second dielectric material. In other embodiments, however, the THz waveguides 2312 are embedded within the THz interposers 2220. In some such embodiments, the THz interposers 2220 may not comprise the dielectric material.

The dielectric material may be selected from a group consisting of high-resistivity float zone silicon (HRFZ-Si), germanium (Ge), and diamond-like carbon (DLC). In embodiments with the first dielectric material and the second dielectric material, the first dielectric material may be selected from the group consisting of HRFZ-Si, Ge, and DLC, while the second dielectric material may be another dielectric material, such as a polymer or glass, for example. In some embodiments, the dielectric material may be monocrystalline (i.e., single-crystal). However, in other embodiments, the dielectric material may be polycrystalline (i.e., multi-crystal) or amorphous.

In some embodiments, at least one of the THz waveguides 2312 may have one or more turns between the first waveguide end 2316a and the second waveguide end 2316b. In some such embodiments, each of the one or more turns may have an angle in a range between 25 and 155 degrees. For example, at least one of the THz waveguides 2312 may have a first waveguide portion 2324a and a second waveguide portion 2324b (collectively the “waveguide portions 2324” or each individually a “waveguide portion 2324”), where the first waveguide portion 2324a extends along the z axis and the second waveguide portion 2324b extends across the xy plane.

In some embodiments, at least one of the waveguide portions 2324 has a first cross-sectional geometry at one end and a second cross-sectional geometry at the second end. That is, in such embodiments, at least one of the waveguide portions 2324 may gradually transition between the first cross-sectional geometry and the second cross-sectional geometry.

Each of the THz waveguides 2312 may have a first cross-sectional dimension d₁ and a second cross-sectional dimension d₂ greater than the first cross-sectional dimension. In some embodiments, the first cross-sectional dimension is in a range between 25 micrometers (μm) and 75 μm and the second cross-sectional dimension is in a range between 200 μm and 300 μm. However, as described above, the cross-sectional geometry—which is at least in some part defined by the first cross-sectional dimension d₁ and the second cross-sectional dimension d₂—may gradually transition between the first waveguide end 2316a and the second waveguide end 2316b.

As shown in FIG. 23C, the second waveguide portion 2324b of at least one of the THz waveguides 2312 may comprise one of one or more waveguide cores 2328a-n (hereinafter the “waveguide cores 2328” or each individually a “waveguide core 2328”)—such as a first waveguide core 2328a of the first THz waveguide 2312a and a second waveguide core 2328b of the second THz waveguide 2312b shown in FIG. 23C. The waveguide core 2328 of each of the THz waveguides 2312 may be centrally disposed within such THz waveguide 2312 (i.e., spaced a distance from at least two of the interior surfaces 2320 which form the waveguide sidewalls of the THz waveguide 2312), and the interior surfaces 2320 defining each of the THz waveguides 2312 and the waveguide core 2328 of each of the THz waveguides 2312 may define a cladding region 2332 (collectively the “cladding regions 2332”)—such as a first cladding region 2332a of the first THz waveguide 2312a and a second cladding region 2332b of the second THz waveguide 2312b shown in FIG. 23C—between the interior surfaces 2320 and the waveguide core 2328.

In some embodiments, the cladding regions 2332 may comprise one of a gas (e.g., air), a dielectric, and a semiconductor. However, in other embodiments, the cladding regions 2332 may be a vacuum.

In one exemplary embodiment, the waveguide core 2328 of at least one of the THz waveguides 2312 may have a first dimension in a range between 25 μm and 200 μm and a second dimension in a range between 50 μm and 300 μm.

In some embodiments, the waveguide core 2328 of at least one of the THz waveguides 2312 may be suspended within the cladding region 2332 of such THz waveguide 2312. To achieve such suspension, the waveguide core 2328 may be supported by periodically spaced (i.e., along a length of the THz waveguides 2312) support structures, such as crossbars, or by continuous connections to the top and/or bottom of such THz waveguide 2312. In some embodiments, the waveguide core 2328 may be a dielectric rod waveguide (DRW) having one or more portions surrounded by a gas, such as air.

In some embodiments, the waveguide core 2328 of at least one of the THz waveguides 2312 may include a protective layer covering at least a portion of a surface of the waveguide core 2328. In some such embodiments, the protective layer may comprise an oxide. The protective layer may be configured to limit or mitigate degradation over time.

In some embodiments, at least one of the THz waveguides 2312 may be configured to maintain a signal polarization of the THz signals as the THz signals propagate between the first waveguide end 2316a and the second waveguide end 2316b of the THz waveguides 2312.

As shown in FIG. 23B, the upper exterior surface 2300a and the lower exterior surface 2300b of at least one of the THz interposers 2220 may define one or more first through-hole apertures 2336a (hereinafter the “upper through-hole apertures 2336a” or each individually an “upper through-hole aperture 2336a”) and one or more second through-hole apertures 2336b (hereinafter the “lower through-hole apertures 2336b” or each individually a “lower through-hole aperture 2336b”), respectively, and the interior surfaces 2320 of such THz interposers 2220 may define one or more through-holes 2340a-n (hereinafter the “through-holes 2340” or each individually a “through-hole 2340”), each of the through-holes 2340 extending between a respective one of the upper through-hole apertures 2336a and a respective one of the lower through-hole apertures 2336b—such as a first through-hole 2340a shown in FIG. 23B. In alternative embodiments, stacking may be achieved without the through-holes 2340 using evanescent directional coupling between vertically overlapping waveguides, as described in more detail below.

For purposes of clarity, only one of the through-holes 2340 is labeled with a reference character. In the embodiment shown in FIGS. 23A-23E, each of the through-holes 2340 of the second THz interposer 2220b is laterally aligned (i.e., in the xy plane) with a respective one of the first ports 2304 of the first THz interposer 2220a and laterally spaced (i.e., in the xy plane) from each of the THz waveguides 2312 of the second THz interposer 2220b.

In some embodiments, at least one (and preferably all) of the THz waveguides 2312 may be at least partially surrounded by a conductive shielding structure to reduce interference between adjacent THz waveguides 2312. That is, in such embodiments, one or more conductive walls 2344a-n (hereinafter the “conductive walls 2344”)—such as a first conductive wall 2344a shown in FIG. 23C—may be disposed between each of the THz waveguides 2312 and/or one or more conductive layers 2348a-n (hereinafter the “conductive layers 2348”)—such as a first conductive layer 2348a, a second conductive layer 2348b, and a third conductive layer 2348c shown in FIG. 23C—may be disposed between each of the THz interposers 2220. For purposes of clarity, only one of the conductive walls 2344 (i.e., the first conductive wall 2344a) is labeled with a reference character.

The conductive shielding structures may be configured to limit or mitigate cross-talk between adjacent ones of the THz waveguides 2312. The conductive shielding structures may be continuous (i.e., solid conductive barriers) or non-continuous (e.g., a linear array of conductive vias or a patterned conductive layer). In some embodiments, at least one of the conductive shielding structures (i.e., the conductive walls 2344 and/or the conductive layers 2348) may comprise a metal selected from a group consisting of gold, silver, aluminum, and copper.

Referring now to FIG. 24, shown therein is an exploded isometric view of another exemplary embodiment of a THz interposer assembly 2400 constructed in accordance with the present disclosure.

As described in more detail below, the THz interposer assembly 2400 shown in FIG. 24 may be constructed in a similar manner as the THz interposer assembly 2200 shown in FIG. 22 except that the THz interposer assembly 2400 shown in FIG. 24 comprises four of the THz interposers 2220. That is, the THz interposer assembly 2400 shown in FIG. 24 comprises a third THz interposer 2220c and a fourth THz interposer 2220d in addition to the first THz interposer 2220a and the second THz interposer 2220b.

Because the THz interposer assembly 2400 shown in FIG. 24 comprises the third THz interposer 2220c and the fourth THz interposer 2220d, the THz interposer assembly 2400 shown in FIG. 24 also comprises a third THz waveguide array 2224c corresponding to the third THz interposer 2220c and a fourth THz waveguide array 2224d corresponding to the fourth THz interposer 2220d in addition to the first THz waveguide array 2224a corresponding to the first THz interposer 2220a and the second THz waveguide array 2224b corresponding to the second THz interposer 2220b.

Additionally, because the THz interposer assembly 2400 shown in FIG. 24 comprises the third THz interposer 2220c and the fourth THz interposer 2220d, the THz interposer assembly 2400 shown in FIG. 24 also further comprises a third ASIC 2212c and a fourth ASIC 2212d mounted on the GHz interposer 2208 in addition to the first ASIC 2212a and the second ASIC 2212b as well as a ninth THz transceiver 2216i, a tenth THz transceiver 2216j, an eleventh THz transceiver 2216k, a twelfth THz transceiver 2216l, a thirteenth THz transceiver 2216m, a fourteenth THz transceiver 2216n, a fifteenth THz transceiver 2216o, and a sixteenth THz transceiver 2216p in addition to the first THz transceiver 2216a, the second THz transceiver 2216b, the third THz transceiver 2216c, and the fourth THz transceiver 2216d.

In the embodiment shown in FIG. 24, the ninth THz transceiver 2216i, the tenth THz transceiver 2216j, the eleventh THz transceiver 2216k, and the twelfth THz transceiver 2216l correspond to the third ASIC 2212c and are coupled thereto via the GHz interposer 2208, and the thirteenth THz transceiver 2216m, the fourteenth THz transceiver 2216n, the fifteenth THz transceiver 2216o, and the sixteenth THz transceiver 2216p correspond to the fourth ASIC 2212d and are coupled thereto via the GHz interposer 2208.

As described above, the THz interposers 2220 of the THz interposer assembly 2200 may be configured to be stackable to achieve higher bandwidth. FIG. 24 illustrates a 6.4 Tbps configuration with four of the THz interposers 2220.

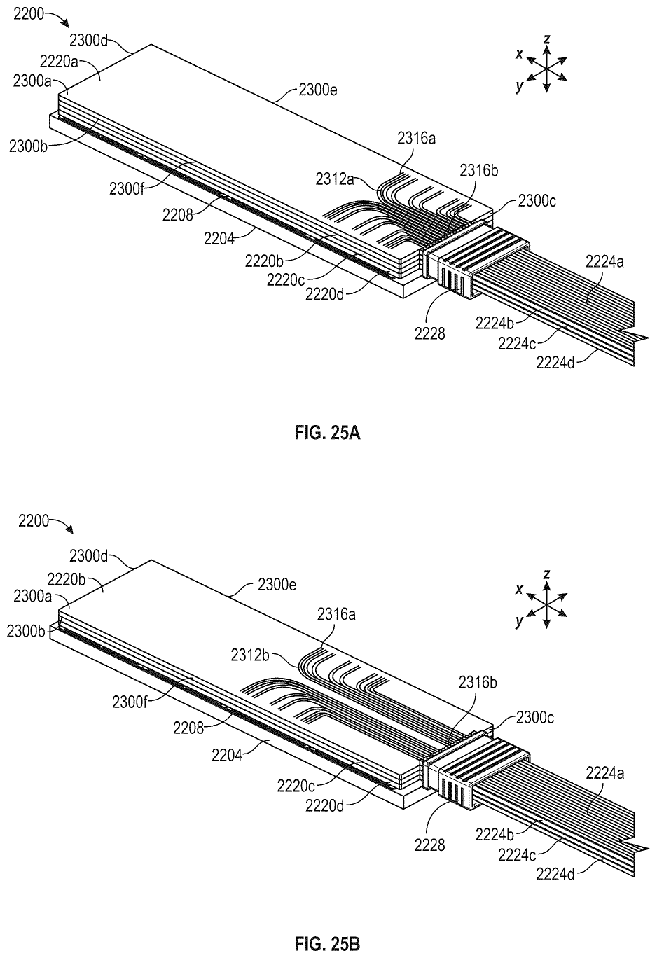

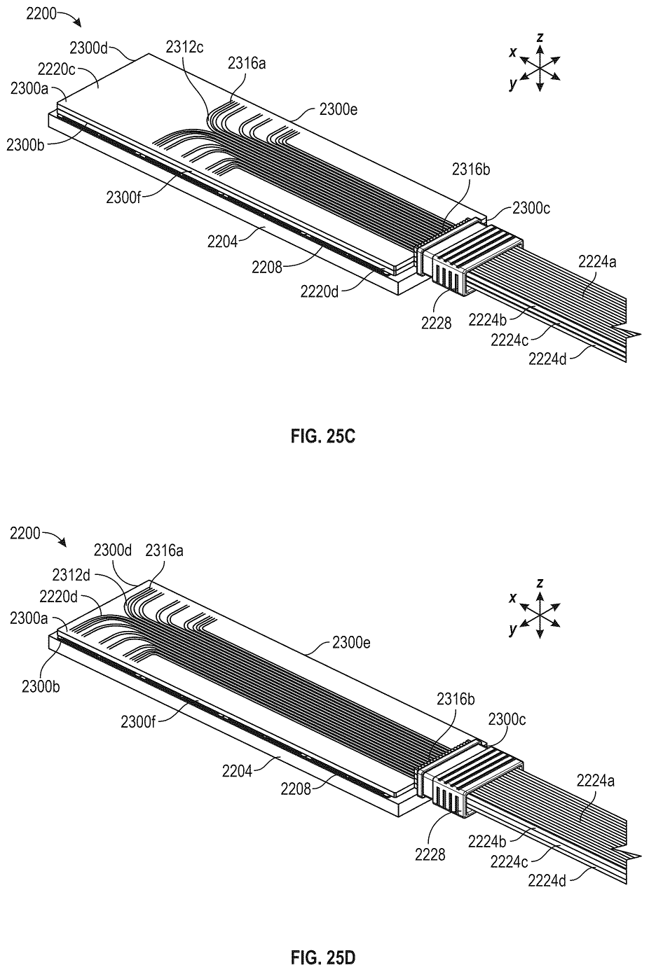

Referring now to FIGS. 25A-25D, shown therein are: an isometric view of the THz interposer assembly 2400 shown in FIG. 24, wherein the cover 2232 has been removed such that the first THz interposer 2220a may be seen (FIG. 25A); another isometric view of the THz interposer assembly 2400 shown in FIG. 24, wherein the cover 2232 and the first THz interposer 2220a have been removed such that the second THz interposer 2220b may be seen (FIG. 25B); another isometric view of the THz interposer assembly 2400 shown in FIG. 24, wherein the cover 2232, the first THz interposer 2220a, and the second THz interposer 2220b have been removed such that the third THz interposer 2220c may be seen (FIG. 25C); and another isometric view of the THz interposer assembly 2400 shown in FIG. 24, wherein the cover 2232, the first THz interposer 2220a, the second THz interposer 2220b, and the third THz interposer 2220c have been removed such that the fourth THz interposer 2220d may be seen (FIG. 25D).

In an alternative embodiment, at least one of the THz interposers 2220 may be mounted below the THz transceivers 2216. In this configuration, the THz transceivers 2216 may be flipped such that the antennas of each of the THz transceivers 2216 may point downward (i.e., toward the PCB 2204). In such embodiments, outbound THz signals may travel from the antennas of the THz transceivers 2216 into a first port 2304 on the upper exterior surface 2300a of the THz interposer 2220. The THz waveguide 2312 may then route the outbound THz signals downward (e.g., toward the PCB 2204), make a first bend (by, e.g., 90 degrees), route horizontally (e.g., in the xy plane) to extend beyond the edge of the THz transceiver 2216, make a second bend (by, e.g., 90 degrees) to route upward (e.g., away from the PCB 2204), and exit through a second port 2308 also on the upper exterior surface 2300a of the THz interposer 2220. In this “U-turn” embodiment, both the first port 2304 and the second port 2308 may be defined by the same exterior surface (e.g., the upper exterior surface 2300a).

To mitigate propagation loss due to radiation at the first bend and the second bend, the THz waveguide 2312 may be configured with a predetermined minimum bend radius. In some embodiments, the bend radius may be greater than 200 μm to ensure the THz mode remains confined within the waveguide core 2328 during the change in direction.

In some embodiments, the THz interposer assembly 2200 may further comprise a thermal pad (not shown) disposed on the lower exterior surface 2300b and having a first pad surface, a second pad surface opposite the first pad surface, and one or more openings extending between the first pad surface and the second pad surface and defined by the first pad surface and the second pad surface, at least one of the one or more openings laterally aligned with a respective one of the first ports 2304 or a respective one of the second ports 2308 to permit passage of the THz signals through the thermal pad.

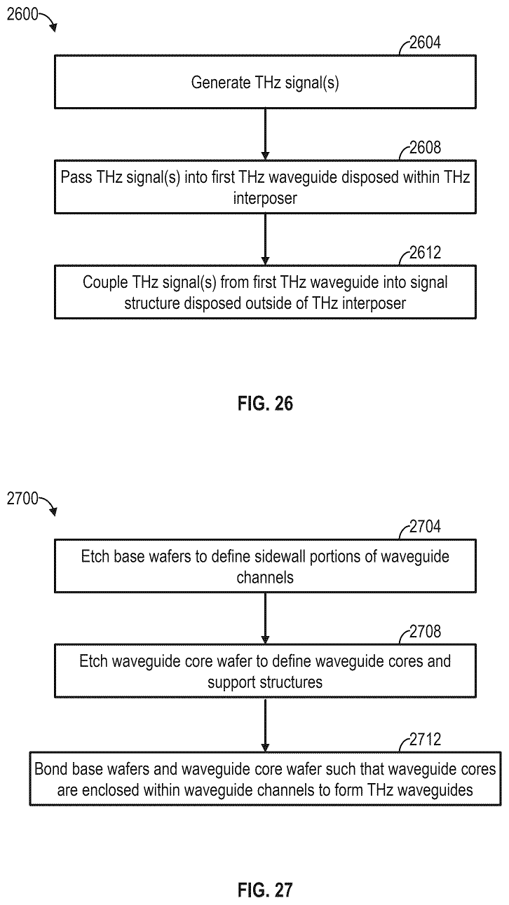

Referring now to FIG. 26, shown therein is a process flow diagram of an exemplary embodiment of a method 2600 of using the THz interposer assembly 2200, 2400, 2900 (shown in FIG. 29A) in accordance with the present disclosure.

As shown in FIG. 26, the method 2600 generally comprises the steps of: generating, by a substrate-integrated antenna (e.g., antenna array 520) of a THz transmitter 500, one or more THz signals having a frequency in a range between 300 GHz and 10 THz (step 2604); coupling the one or more THz signals into a first THz waveguide 2312a disposed within a THz interposer 2220a (step 2608); and
coupling the one or more THz signals from the first THz waveguide 2312a into a signal structure (e.g., a THz waveguide of the first THz waveguide array 2224a) disposed outside of (i.e., external to) the first THz interposer 2220a (step 2612).

Referring now to FIG. 27, shown therein is a process flow diagram of an exemplary embodiment of a method 2700 of constructing the THz interposer assembly 2200, 2400 in accordance with the present disclosure.

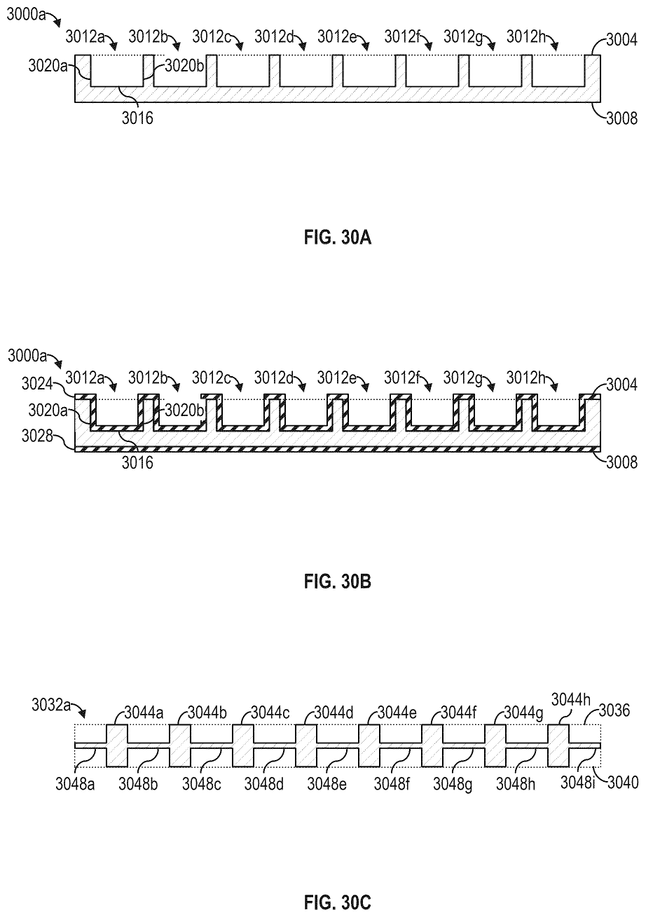

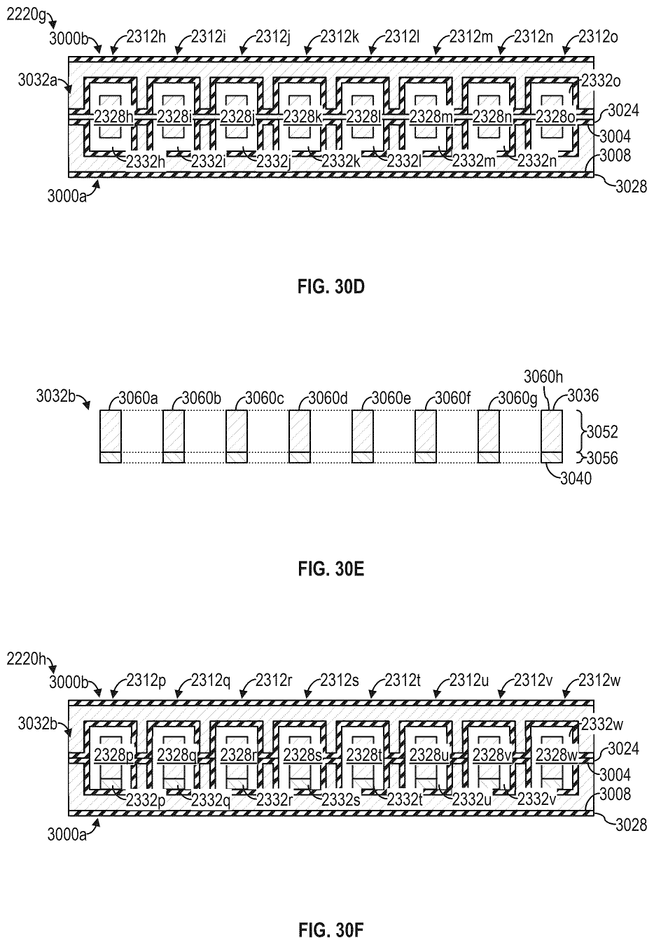

As shown in FIG. 27, the method 2700 generally comprises the steps of: etching a plurality of base wafers 3000 (shown in FIGS. 30A-30E) to define a sidewall portion of a plurality of waveguide channels (defined by, e.g., interior surfaces 2320) (step 2704); etching a waveguide core wafer 3032 (shown in FIGS. 30C-30E) to define a plurality of waveguide cores 2328 and a plurality of support structures 3048 (shown in FIGS. 30C-30D), 3060 (shown in FIGS. 30E-30F) (step 2708); positioning the waveguide cores 2328 and the plurality of support structures within a first one of the base wafers 3000, inverting a second one of the base wafers 3000 and placing the inverted second one of the base wafers 3000 onto the first base wafer so that each of the waveguide cores 2328 is suspended and surrounded by a gas, such as air, and bonding the plurality of base wafers 3000 and the waveguide core wafer 3032 such that each of the plurality of waveguide cores 2328 are enclosed within the respective one of the plurality of waveguide channels to form a plurality of THz waveguides 2312 (step 2712); wherein each of the plurality of THz waveguides 2312 extends between a respective one of a plurality of first ports 2304 and a respective one of a plurality of second ports 2308 and is configured to propagate, between the respective one of the plurality of first ports 2304 and the respective one of the plurality of second ports 2308, one or more THz signals having a frequency in a range between 300 GHz and 10 THz with a propagation loss in a range between 0.001-1.0 dB per cm. As discussed above, the base wafer(s) 3000 can be constructed of a dielectric material configured to propagate THz signals having a frequency in a range between 300 (GHz and 10 THz with a propagation loss in a range between 0.001 and 1.0 dB per cm. Suitable dielectric materials include, but are not limited to, high-resistivity float zone silicon (HRFZ-Si), germanium (Ge), and diamond-like carbon (DLC) having a DC resistance or an impedance in the THz band in a range between 10 kiloohm (kΩ)-cm and 100 kΩ-cm and an air cladding surrounding the dielectric material.

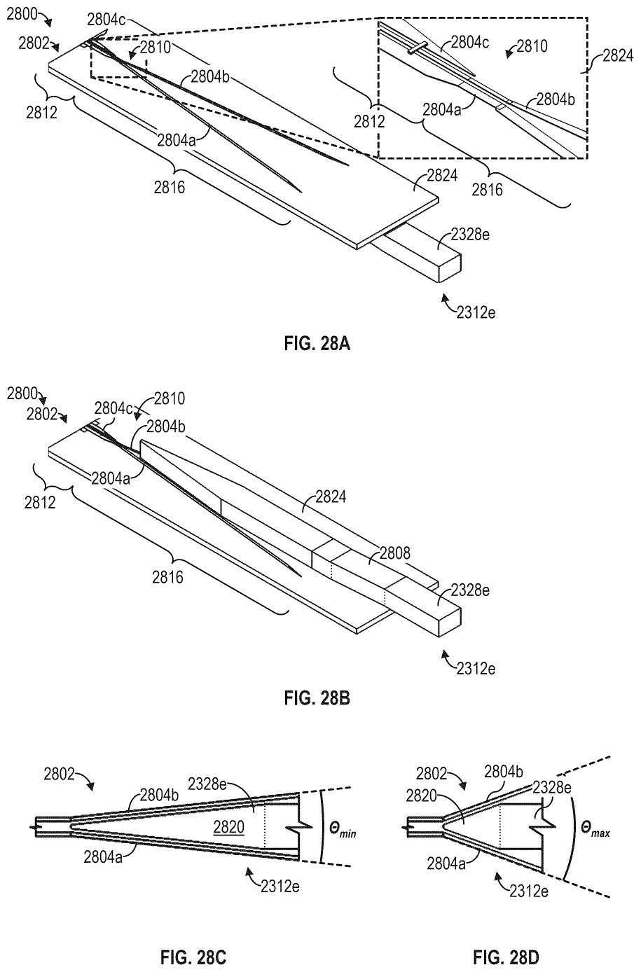

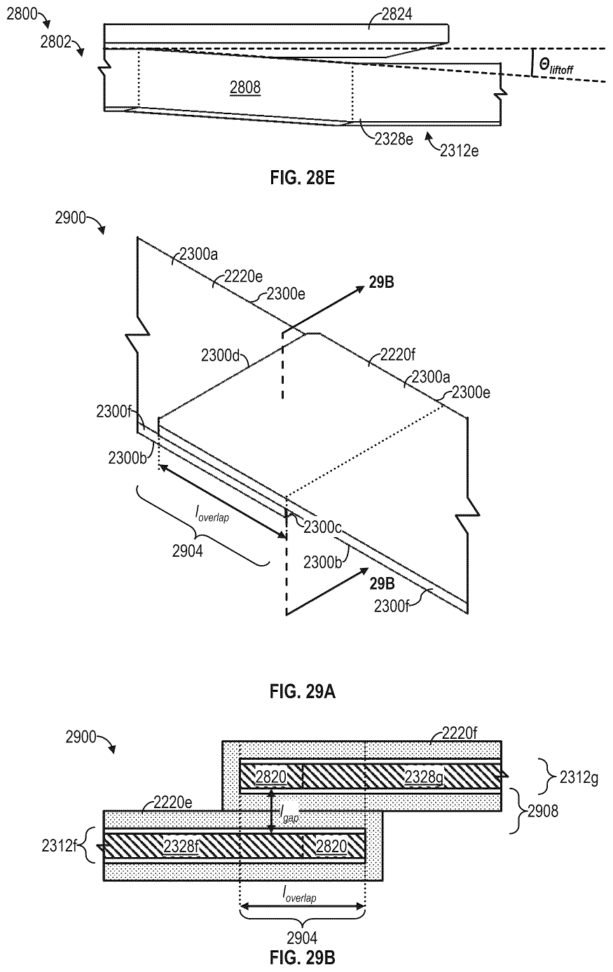

Referring now to FIGS. 28A-28E, shown therein are: an isometric view of a portion of another exemplary embodiment of a THz interposer assembly 2800 constructed in accordance with the present disclosure, wherein the THz interposer assembly 2800 comprises a coplanar stripline (CPS) coupling structure 2802 configured for evanescent coupling of the THz signals into or out of a fifth waveguide core 2328e of a fifth THz waveguide 2312e (FIG. 28A); an isometric view of a portion of another exemplary embodiment of the THz interposer assembly 2800 shown in FIG. 28A, wherein the CPS coupling structure 2802 is in a coplanar relationship with the fifth THz waveguide 2312e and is configured for directly coupling the THz signals into or out of the fifth waveguide core 2328e of the fifth THz waveguide 2312e (FIG. 28B); a partial top view of the CPS coupling structure 2802 shown in FIG. 28B, illustrating a minimum expansion angle Θₘᵢₙ of a plurality of conductive traces 2804a-n (hereinafter the “conductive traces 2804”) (FIG. 28C); another partial top view of the CPS coupling structure 2802 shown in FIG. 28B, illustrating a maximum expansion angle Θₘₐₓ of the conductive traces 2804 (FIG. 28D); and a perspective view of the CPS coupling structure 2802 shown in FIG. 28A, illustrating the fifth THz waveguide 2312e having an evanescent coupling region including a liftoff section 2808 (FIG. 28E). Although the THz interposer assembly 2800 is shown with only one CPS coupling structure 2802 and the fifth waveguide core of the fifth THz waveguide 2312e, it should be understood that the THz interposer assembly 2800 may include a CPS coupling structure for each THz waveguide in the THz interposer assembly 2800. For example, if the THz interposer assembly 2800 includes 16 THz waveguides, then the THz interposer assembly 2800 may also include 16 CPS coupling structures 2802 with each CPS coupling structure 2802 associated with a particular THz waveguide.

As described above, in some embodiments, at least one of the first ports 2304 and/or the second ports 2308 may be implemented as a CPS coupling structure (e.g., the CPS coupling structure 2802 shown in FIGS. 28A-28E). The CPS coupling structure 2802 may be generally configured to couple an electric field of the THz signals between the conductive traces 2804 and the fifth THz waveguide 2312e to thereby evanescently couple the electric field into or out of the fifth THz waveguide 2312e.

In a transition region 2810, the CPS coupling structure 2802 may transition between a Ground-Signal-Ground (GSG) configuration 2812 having three of the conductive traces 2804 (i.e., a first conductive trace 2804a, a second conductive trace 2804b, and a third conductive trace 2804c) and a balanced Ground-Signal (GS) configuration 2816 having two of the conductive traces (i.e., the first conductive trace 2804a and the second conductive trace 2804b but absent of the third conductive trace 2804c) for evanescent or direct coupling with the fifth THz waveguide 2312e. In such embodiment, the first conductive trace 2804a and the third conductive trace 2804c are ground connections, while the second conductive trace 2804b is a signal connection. In the CPS coupling structure 2802 the first conductive trace 2804a and the second conductive trace 2804b may be coplanar.

As shown in FIGS. 28C and 28D, the conductive traces 2804 (i.e., the first conductive trace 2804a and the second conductive trace 2804b) may expand at an expansion angle which may be in a range between the minimum expansion angle Θₘᵢₙ shown in FIG. 28C and the maximum expansion angle Θₘₐₓ shown in FIG. 28D. In some embodiments, the minimum expansion angle Θₘᵢₙ may be 6 degrees and the maximum expansion angle Θₘₐₓ may be 20 degrees relative to a longitudinal axis of the fifth THz waveguide 2312e. The fifth THz waveguide 2312e may be disposed between the conductive traces 2804 and the fifth waveguide core 2328e may have a tapered region 2820 that narrows to a second width smaller than a first width of the remainder of the fifth waveguide core 2328e to facilitate mode transfer. In some embodiments, the second width may be greater than 75 μm.

The tapered region 2820 of the fifth waveguide core 2328e and the conductive traces 2804 may provide added tolerance to misalignment between the THz interposer 2220 and the THz transceiver 2216. For example, the gradual expansion of the optical mode from the conductive traces 2804 into the fifth waveguide core 2328e may allow for lateral misalignments between the signal source and the fifth waveguide core 2328e while maintaining an insertion loss in a range between 0.001 dB and 1.0 dB.

In some embodiments, the conductive traces 2804 may be disposed on a dielectric layer 2824, which in some embodiments may comprise BCB. Further, in some embodiments, a floating conductive layer (not shown) may be disposed on one of the exterior surfaces 2300 of the THz interposer 2220 beneath the dielectric layer 2824 and the conductive traces 2804. This floating conductive layer may be electrically isolated from ground to facilitate mode confinement and maintain electric field symmetry during the transition of the THz signals between the CPS coupling structure 2802 and the fifth THz waveguide 2312e.

As shown in FIG. 28E, as the fifth THz waveguide 2312e extends into the THz interposer 2220 from the CPS coupling structure 2802 (i.e., in the liftoff section 2808), the fifth THz waveguide 2312e may be angled away from the exterior surface 2300 at an angle Θ_{liftoff} to gradually increase a distance between the fifth THz waveguide 2312e and the conductive traces 2804. This gradual separation may improve the mode transfer efficiency and/or reduce signal loss at the interface.

Referring now to FIGS. 29A-29B, shown therein are: a partial isometric view of another exemplary embodiment of a THz interposer assembly 2900 constructed in accordance with the present disclosure, illustrating a vertical overlap between a fifth THz interposer 2220e and a sixth THz interposer 2220f (FIG. 29A); and a cross-sectional view of the THz interposer assembly 2900 shown in FIG. 29A, taken along the line 29B-29B and in the direction of the arrows, illustrating an evanescent coupling between a sixth THz waveguide 2312f and a seventh THz waveguide 2312g (FIG. 29B).

As shown in FIGS. 29A-29B, the THz interposer assembly 2900 may utilize evanescent directional coupling. The sixth THz waveguide 2312f in the fifth THz interposer 2220e may overlap with the seventh THz waveguide 2312g in the sixth THz interposer 2220f to form a longitudinal overlap region 2904 separated by a latitudinal gap 2908 between the sixth THz waveguide 2312f and the seventh THz waveguide 2312g. The longitudinal overlap region 2904 may have a length lₒᵥₑᵣₗₐₚ extending along the longitudinal axis in a range between 200 μm and 440 μm. To ensure efficient directional coupling, the tips of the THz waveguides 2312 within the longitudinal overlap region 2904 may have the tapered region 2820 (i.e., similar to the THz waveguides 2312 shown in FIGS. 28C-28D) to facilitate the transfer of the THz signals across the latitudinal gap 2908. The latitudinal gap 2908 may have a predetermined length l_{gap} in a range between 2 μm and 45 μm.

Shown in FIGS. 30A-30F are diagrammatic cross-sectional views showing steps in processes for making the THz interposer 2220, for example.

Referring now to FIG. 30A, shown therein is a cross-sectional view of a portion of a first base wafer 3000a constructed in accordance with the present disclosure at a first instant in time.

As shown in FIG. 30A, the first base wafer 3000a may have an inner surface 3004 and an outer surface 3008 opposite the inner surface 3004. The first base wafer 3000a may comprise the dielectric material, which may be selected from a group consisting of HRFZ-Si, Ge, or DLC, for example.

In the construction of one or more of the THz interposers 2220 described herein, the inner surface 3004 of the first base wafer 3000a may be etched to define a plurality of trenches 3012a-n (hereinafter the “trenches 3012”). In the embodiment shown in FIG. 30A, the inner surface 3004 of the first base wafer 3000a has been etched to define eight of the trenches 3012 (i.e., a first trench 3012a, a second trench 3012b, a third trench 3012c, a fourth trench 3012d, a fifth trench 3012e, a sixth trench 3012f, a seventh trench 3012g, and an eighth trench 3012h). However, it should be understood that the inner surface 3004 of the first base wafer 3000a may be etched to define a number of the trenches 3012 greater or fewer than eight.

Each of the trenches 3012 may have a trench floor 3016 recessed below the inner surface 3004 (i.e., between the inner surface 3004 and the outer surface 3008) and a pair of trench sidewalls 3020a-b (hereinafter the “trench sidewalls 3020”) (i.e., a first trench sidewall 3020a and a second trench sidewall 3020b) extending between the trench floor 3016 and the inner surface 3004. For purposes of clarity, only the trench floor 3016 and the trench sidewalls 3020 of the first trench 3012a are labeled with reference characters.

Referring now to FIG. 30B, shown therein is a cross-sectional view of the portion of the first base wafer 3000a shown in FIG. 30A at a second instant in time.

As shown in FIG. 30B, an inner conductive layer 3024 may be applied to the inner surface 3004 of the first base wafer 3000a—including the trench floor 3016 and the trench sidewalls 3020 of each of the trenches 3012—and an outer conductive layer 3028 may be applied to the outer surface 3008 of the first base wafer 3000a. As referenced above, the inner conductive layer 3024 and the outer conductive layer 3028 may comprise a metal selected from a group consisting of gold, silver, aluminum, and copper, for example.

Referring now to FIG. 30C, shown therein is a cross-sectional view of a portion of a first waveguide core wafer 3032a constructed in accordance with the present disclosure.

As shown in FIG. 30C, the first waveguide core wafer 3032a may have a first surface 3036 and a second surface 3040 opposite the first surface 3036. The first waveguide core wafer 3032a may comprise the dielectric material, which may be selected from a group consisting of HRFZ-Si, Ge, or DLC, for example.

In the construction of one or more of the THz interposers 2220 described herein, the first surface 3036 and the second surface 3040 of the first waveguide core wafer 3032a may be etched to define a plurality of suspendable waveguide cores 3044a-n (hereinafter the “suspendable waveguide cores 3044”)—such as a first suspendable waveguide core 3044a, a second suspendable waveguide core 3044b, a third suspendable waveguide core 3044c, a fourth suspendable waveguide core 3044d, a fifth suspendable waveguide core 3044e, a sixth suspendable waveguide core 3044f, a seventh suspendable waveguide core 3044g, and an eighth suspendable waveguide core 3044h shown in FIG. 30C—interleaved with a plurality of support structures 3048a-n (hereinafter the “support structures 3048”)—such as a first support structure 3048a, a second support structure 3048b, a third support structure 3048c, a fourth support structure 3048d, a fifth support structure 3048e, a sixth support structure 3048f, a seventh support structure 3048g, an eighth support structure 3048h, and a ninth support structure 3048i having a thickness less than a thickness of the suspendable waveguide cores 3044.

While the support structures 3048 of the first waveguide core wafer 3032a are shown as being coplanar and aligned with each other, it should be understood that the support structures 3048 may be spaced from each other across a length of the first waveguide core wafer 3032a.

Referring now to FIG. 30D, shown therein is a cross-sectional view of a portion of a seventh THz interposer 2220g constructed in accordance with the present disclosure.

As shown in FIG. 30D, the first waveguide core wafer 3032a may be disposed between the inner conductive layer 3024 of the first base wafer 3000a and the inner conductive layer 3024 of a second, inverted base wafer 3000b, and the first base wafer 3000a, the first waveguide core wafer 3032a, and the second, inverted base wafer 3000b may be bonded together to form the seventh THz interposer 2220g such that each of the suspendable waveguide cores 3044 are suspended by the support structures 3048 and becomes the THz waveguide core 2328 of a respective one of the THz waveguides 2312 of the seventh THz interposer 2220g, each of the THz waveguides 2328 is spaced from the conductive layers 3024 of both the first base wafer 3000a and the second, inverted base wafer 3000b, and the cladding regions 2332 (e.g., a gas such as air) of each of the THz waveguides 2312 are formed between the conductive layers 3024 of the base wafers 3000 and a respective one of the suspended waveguide cores 3044.

The second, inverted base wafer 3000b may be constructed in a similar manner as the first base wafer 3000a and may comprise the dielectric material, which may be selected from a group consisting of HRFZ-Si, Ge, and DLC, for example.

Referring now to FIG. 30E, shown therein is a cross-sectional view of a portion of a second waveguide core wafer 3032b constructed in accordance with the present disclosure.

The second waveguide core wafer 3032b may be constructed in a similar manner as the first waveguide core wafer 3032a, except that the second waveguide core wafer 3032b may have two layers: a waveguide core layer 3052 and a support layer 3056. The waveguide core layer 3052 may comprise the dielectric material, which may be selected from a group consisting of HRFZ-Si, Ge, and DLC, for example, while the support layer 3056 may comprise another dielectric material with a lower dielectric constant than the dielectric material of the waveguide core layer 3052. For example, in embodiments in which the dielectric material of the waveguide core layer 3052 is silicon, which has a dielectric constant of approximately 11.7 at room temperature, the dielectric material of the support layer 3056 may be silica (SiO₂), which has a dielectric constant of approximately 3.9 at room temperature, for example.

In the construction of one or more of the THz interposers 2220 described herein, the first surface 3036 and the second surface 3040 of the second waveguide core wafer 3032b may be etched to define a plurality of supported waveguide cores 3060a-n (hereinafter the “supported waveguide cores 3060”)—such as a first supported waveguide core 3060a, a second supported waveguide core 3060b, a third supported waveguide core 3060c, a fourth supported waveguide core 3060d, a fifth supported waveguide core 3060e, a sixth supported waveguide core 3060f, a seventh supported waveguide core 3060g, and an eighth supported waveguide core 3060h shown in FIG. 30E. Each of the supported waveguide cores 3060 may comprise the waveguide core layer 3052 and the support layer 3056. In some embodiments, the waveguide core layer 3052 and the support layer 3056 may be bonded to each other before the first surface 3036 and the second surface 3040 are etched. However, in other embodiments, the waveguide core layer 3052 and the support layer 3056 may be bonded to each other after the first surface 3036 and the second surface 3040 are etched.

Referring now to FIG. 30F, shown therein is a cross-sectional view of a portion of an eighth THz interposer 2220h constructed in accordance with the present disclosure.

As shown in FIG. 30F, the second waveguide core wafer 3032b may be disposed between the inner conductive layer 3024 of the first base wafer 3000a and the inner conductive layer 3024 of the second, inverted base wafer 3000b, and the first base wafer 3000a, the second waveguide core wafer 3032b, and the second, inverted base wafer 3000b may be bonded together to form the eighth THz interposer 2220h such that each of the supported waveguide cores 3060 becomes the THz waveguide core 2328 of a respective one of the THz waveguides 2312 of the eighth THz interposer 2220h, each of the THz waveguides 2328 is spaced from the conductive layers 3024 of both the first base wafer 3000a and the second, inverted base wafer 3000b, and the cladding regions 2332 of each of the THz waveguides 2312 are formed between the conductive layers 3024 of the base wafers 3000 and a respective one of the supported waveguide cores 3060.

### ILLUSTRATIVE CLAUSES

Exemplary, non-limiting illustrative clauses are provided in the clauses below. However, the scope of the present inventive concept(s) is to be understood to not be limited in any manner by the clauses presented below.

Illustrative clause 1. A landing connector, comprising: a first waveguide configured to receive at least a portion of an antenna; a second waveguide intersecting the first waveguide at an intersection; and a reflector positioned at the intersection and configured to reflect an electromagnetic wave having data encoded within a carrier frequency in a range between 300 GHz and 10 THz.

Illustrative clause 2. The landing connector of illustrative clause 1, further comprising a body having the first waveguide, the second waveguide, and the reflector positioned therein.

Illustrative clause 3. The landing connector of illustrative clause 1, wherein an angle of the intersection between the first waveguide and the second waveguide is at about 90 degrees.

Illustrative clause 4. The landing connector of illustrative clause 1, wherein an angle of the intersection between the first waveguide and the second waveguide is between about 60 degrees and about 135 degrees.

Illustrative clause 5. The landing connector of illustrative clause 1, wherein the first waveguide is further configured to interface with an antenna to receive the electromagnetic wave from the antenna.

Illustrative clause 6. The landing connector of illustrative clause 5, wherein the first waveguide is further configured to receive the antenna within the first waveguide.

Illustrative clause 7. The landing connector of illustrative clause 1, further comprising one or more coupling member operable to fasten the landing connector onto a printed circuit board, integrated circuit, or redistribution layer.

Illustrative clause 8. The landing connector of illustrative clause 1, wherein the electromagnetic wave has a wavelength and wherein the first waveguide has a first cross-sectional dimension and the second waveguide has a second cross-sectional dimension, the first cross-sectional dimension and the second cross-sectional dimension being in a range between ¼ wavelength and 50 wavelengths of the electromagnetic wave.

Illustrative clause 9. The landing connector of illustrative clause 1, further comprising: a landing body comprising a uniform material and having a first surface and a second surface and the reflector positioned within the landing body; and wherein the first waveguide extends from the first surface to the reflector at the intersection and the second waveguide extends from the second surface to the reflector at the intersection forming an interior surface, the interior surface being constructed of a conductive material.

Illustrative clause 10. The landing connector of illustrative clause 1, wherein the intersection is a first intersection and the reflector is a first reflector, and further comprising: a third waveguide disposed apart from the first waveguide; a fourth waveguide disposed apart from the second waveguide and intersecting the third waveguide at a second intersection; and a second reflector positioned at the second intersection and configured to reflect a second electromagnetic wave having data encoded within a carrier frequency in a range between 300 GHz and 10 THz.

Illustrative clause 11. The landing connector of illustrative clause 10, wherein the third waveguide is disposed substantially parallel with the first waveguide and the fourth waveguide is disposed substantially parallel with the second waveguide.

Illustrative clause 12. The landing connector of illustrative clause 10, wherein the first waveguide, the second waveguide, the third waveguide, and the fourth waveguide are coplanar with each other.

Illustrative clause 13. The landing connector of illustrative clause 10, wherein the third waveguide and the first waveguide are coplanar along a first plane; and the fourth waveguide and the second waveguide are coplanar along a second plane, the first plane and the second plane being different.

Illustrative clause 14. The landing connector of illustrative clause 13, wherein the first plane and the second plane intersect at an angle of about 90 degrees.

Illustrative clause 15. The landing connector of illustrative clause 13, wherein the first plane and the second plane intersect at an angle of between 10 degrees and 135 degrees.

Illustrative clause 16. The landing connector of illustrative clause 13, wherein the reflector is positioned along a third plane, and wherein the first plane intersects the third plane at a first angle of incidence and the second plane intersects the third plane at a second angle of incidence equal to the first angle of incidence.

Illustrative clause 17. A landing connector, comprising: a first waveguide configured to couple to a substrate integrated waveguide; a second waveguide intersecting the first waveguide at an intersection; and a reflector positioned at the intersection and configured to direct an electromagnetic wave having data encoded within a carrier frequency in a range between 300 GHz and 10 THz from the first waveguide to the second waveguide.

Illustrative clause 18. The landing connector of illustrative clause 17, wherein the first waveguide and the second waveguide are WR-1 waveguides.

Illustrative clause 19. The landing connector of illustrative clause 17, wherein the first waveguide intersects the second waveguide at an angle less than 60 degrees.

Illustrative clause 20. The landing connector of illustrative clause 17, wherein the second waveguide further comprises a first cross-sectional dimension, and further comprising: a third waveguide having a second cross-sectional dimension greater than the first cross-sectional dimension; and a first horn coupled to the second waveguide and the third waveguide and configured to transfer the electromagnetic wave from the second waveguide to the third waveguide.

Illustrative clause 21. The landing connector of illustrative clause 20, wherein the third waveguide is a hollow-core THz waveguide.

Illustrative clause 22. The landing connector of illustrative clause 21, wherein the hollow-core THz waveguide is an elliptical-core fiber.

Illustrative clause 23. A landing connector, comprising: a series of exposed contacts configured to connect to an integrated circuit or distribution board; a coupler to launch an electromagnetic wave having data encoded within a carrier frequency in a range between 300 GHz and 10 THz based on energy received from the series of exposed contacts; a first waveguide configured to accept the electromagnetic wave from the coupler; and a second waveguide intersecting the first waveguide at an intersection to accept the electromagnetic wave from the first waveguide.

Illustrative clause 24. The landing connector of illustrative clause 23, wherein the first waveguide and the second waveguide are WR-1 waveguides.

Illustrative clause 25. The landing connector of illustrative clause 23, further comprising a bend disposed between the coupler and the second waveguide at the intersection and configured to couple the electromagnetic wave from the first waveguide into the second waveguide, and wherein the bend has a curvature of between zero and 60 degrees.

Illustrative clause 26. The landing connector of illustrative clause 25, wherein the curvature is between 15 and 25 degrees.

Illustrative clause 27. The landing connector of illustrative clause 25, wherein the bend further has a bend radius of between 0.1 mm and 1.4 mm.

Illustrative clause 28. The landing connector of illustrative clause 23, wherein the second waveguide further comprises a first cross-sectional dimension, and further comprising: a third waveguide having a second cross-sectional dimension greater than the first cross-sectional dimension; and a horn coupled to the second waveguide and the third waveguide to transfer the electromagnetic wave from the second waveguide to the third waveguide, the horn having a geometric taper from the first cross-sectional dimension of the second waveguide to the second cross-sectional dimension of the third waveguide.

Illustrative clause 29. The landing connector of illustrative clause 28, wherein the third waveguide is a hollow-core THz waveguide.

Illustrative clause 30. The landing connector of illustrative clause 29, wherein the hollow-core THz waveguide is an elliptical-core fiber.

Illustrative clause 31. The landing connector of illustrative clause 22, wherein the electromagnetic wave is a linear-polarized wave.

Illustrative clause 32. The landing connector of illustrative clause 22, wherein the electromagnetic wave comprises a TE10 or HE11 mode.

Illustrative clause 33. A landing connector, comprising: a landing body; and a waveguide formed in the landing body; the waveguide having an interior surface formed by a conductive material, a first opening having a first cross-sectional dimension, and a second opening disposed opposite the first opening and having a second cross-sectional dimension greater than the first cross-sectional dimension, the first cross-sectional dimension configured to receive at least a portion of an antenna; and wherein the waveguide is configured to guide an electromagnetic wave having data encoded within a carrier frequency in a range between 300 GHz and 10 THz.

Illustrative clause 34. The landing connector of illustrative clause 33, wherein the waveguide is a first waveguide, and further comprising: a second waveguide formed in the landing body, the second waveguide having a third opening having the first cross-sectional dimension and a fourth opening disposed opposite the third opening and having the second cross-sectional dimension.

Illustrative clause 35. The landing connector of illustrative clause 33, wherein the first opening has a first cross-sectional shape and the second opening has a second cross-sectional shape, the first cross-sectional shape being different from the second cross-sectional shape.

Illustrative clause 36. The landing connector of illustrative clause 35, wherein the first cross-sectional shape is a rectangle and wherein the second cross-sectional shape is elliptical.

Illustrative clause 37. The landing connector of illustrative clause 35, wherein the interior surface of the waveguide forms a geometric taper from the first opening having the first cross-sectional shape to the second opening having the second cross-sectional shape.

Illustrative clause 38. The landing connector of illustrative clause 33, wherein the interior surface of the waveguide forms a geometric taper from the first opening to the second opening.

Illustrative clause 39. The landing connector of illustrative clause 33, wherein the waveguide is a first waveguide, and wherein the second cross-sectional dimension of the second opening is configured to receive a second waveguide.

Illustrative clause 40. The landing connector of illustrative clause 39, wherein the second waveguide is a hollow-core THz waveguide.

Illustrative clause 41. The landing connector of illustrative clause 40, wherein the hollow-core THz waveguide is an elliptical-core fiber.

Illustrative clause 42. The landing connector of illustrative clause 40, further comprising: a third waveguide having a curve configured such that the electromagnetic wave propagating through the waveguide emerges at an angle between 15 and 25 degrees relative to an initial propagation direction; and wherein the third waveguide is disposed between the first waveguide and the second waveguide.

Illustrative clause 43. A radio frequency guide, comprising: a first horn having a first end, a second end, a first sidewall extending from the first end to the second end, the first sidewall surrounding a first opening extending from the first end to the second end, the first opening having a first input and a first output with the first opening tapering upwardly toward the first output; a second horn having a third end, a fourth end, a second sidewall extending from the third end to the fourth end, the second sidewall surrounding a second opening extending from the third end to the fourth end, the second opening having a second input and a second output with the second opening tapering upwardly toward the second output; a first THz waveguide extending from the first output of the first opening to the second input of the second opening; and a second THz waveguide extending from the second output.

Illustrative clause 44. A fiber array, comprising, a first hollow waveguide having a first major dimension along a first major axis and a first minor dimension along a first minor axis, the first minor dimension being less than the first major dimension; a second hollow waveguide having a second major dimension along a second major axis and a second minor dimension along a second minor axis, the second minor dimension being less than the second major dimension; and a cable body supporting both the first hollow waveguide and the second hollow waveguide; and wherein the first hollow waveguide and the second hollow waveguide are disposed adjacent to each another.

Illustrative clause 45. The fiber array of illustrative clause 44, wherein the first major axis of the first hollow waveguide and the second major axis of the second hollow waveguide are disposed in parallel.

Illustrative clause 46. The fiber array of illustrative clause 45, wherein the cable body has a first bending radius of between 1 cm and 8 cm across the first major axis

Illustrative clause 47. The fiber array of illustrative clause 45, wherein the cable body has a second curvature of between 5 cm and 30 cm across the first minor axis.

Illustrative clause 48. The fiber array of illustrative clause 44, wherein the first major axis of the first hollow waveguide and the second major axis of the second hollow waveguide are coplanar with each other.

Illustrative clause 49. The fiber array of illustrative clause 48, wherein the cable body has a second curvature of between 1 cm and 8 cm across the first minor axis.

Illustrative clause 50. The fiber array of illustrative clause 48, wherein the cable body has a first curvature of between 5 cm and 30 cm across the first major axis.

Illustrative clause 51. The fiber array of illustrative clause 44, wherein both the first hollow waveguide and the second hollow waveguide are polarization maintaining multi-mode waveguides.

Illustrative clause 52. The fiber array of illustrative clause 45, wherein the cable body has a first side, a second side and a width extending between the first side and the second side, and wherein the first major axis and the second major axis are parallel to the width of the cable body.

Illustrative clause 53. A Terahertz (THz) interposer assembly, comprising: a THz interposer defining a plurality of first ports and a plurality of second ports; and a plurality of THz waveguides disposed within the THz interposer, wherein each of the plurality of THz waveguides extends between a respective one of the plurality of first ports and a respective one of the plurality of second ports, and is configured to propagate, between the respective one of the plurality of first ports and the respective one of the plurality of second ports, one or more THz signals having a frequency in a range between 300 Gigahertz (GHz) and 10 THz with a propagation loss in a range between 0.001 decibels (dB) per centimeter (cm) and 1.0 dB per cm.

Illustrative clause 54. The THz interposer assembly of illustrative clause 53, wherein at least a portion of each of the plurality of THz waveguides comprises a dielectric material.

Illustrative clause 55. The THz interposer assembly of illustrative clause 54, wherein the dielectric material is selected from a group consisting of high-resistivity float zone silicon (HRFZ-Si), germanium (Ge), and diamond-like carbon (DLC).

Illustrative clause 56. The THz interposer assembly of illustrative clause 55, wherein the dielectric material is one of monocrystalline, polycrystalline, and amorphous.

Illustrative clause 57. The THz interposer assembly of illustrative clause 54, wherein the THz interposer comprises the dielectric material and has a plurality of interior surfaces defining the plurality of THz waveguides.

Illustrative clause 58. The THz interposer assembly of illustrative clause 54, wherein the THz interposer does not comprise the dielectric material, and the plurality of THz waveguides are embedded in the THz interposer.

Illustrative clause 59. The THz interposer assembly of illustrative clause 53, wherein at least one of the plurality of first ports comprises an aperture defined by an exterior surface of the THz interposer and configured to couple a respective one of the one or more THz signals between the respective one of the plurality of THz waveguides and a signal structure disposed adjacent to the aperture, wherein the signal structure is selected from a group consisting of an antenna, a coplanar stripline, a THz waveguide, and combinations thereof.

Illustrative clause 60. The THz interposer assembly of illustrative clause 53, wherein at least one of the plurality of first ports comprises an evanescent coupling region defined by an exterior surface of the THz interposer and configured to evanescently couple a respective one of the one or more THz signals between the respective one of the plurality of THz waveguides and a signal structure spaced a predetermined distance away from the respective one of the plurality of THz waveguides.

Illustrative clause 61. The THz interposer assembly of illustrative clause 60, wherein the predetermined distance is in a range between 2 micrometers (μm) and 45μm.

Illustrative clause 62. The THz interposer assembly of illustrative clause 60, wherein the evanescent coupling region comprises a liftoff region in which the respective one of the plurality of THz waveguides is angled away from the exterior surface of the THz interposer to gradually increase a distance between the respective one of the plurality of THz waveguides and the signal structure.

Illustrative clause 63. The THz interposer assembly of illustrative clause 53, wherein at least one of the plurality of first ports comprises a coplanar stripline (CPS) coupling structure comprising a pair of conductive traces configured to carry a respective one of the one or more THz signals in a balanced mode and a coupling region in which the pair of conductive traces expands and a waveguide core of the respective one of the plurality of THz waveguides is disposed between the pair of conductive traces, wherein the coupling region is configured to couple an electric field of the one or more THz signals between the pair of conductive traces and the waveguide core.

Illustrative clause 64. The THz interposer assembly of illustrative clause 63, wherein the pair of conductive traces expands in the coupling region at an angle in a range between 6 degrees and 20 degrees relative to a longitudinal axis of the respective one of the plurality of THz waveguides.

Illustrative clause 65. The THz interposer assembly of illustrative clause 63, wherein the waveguide core comprises a tapered region disposed between the pair of conductive traces in which the waveguide core narrows to a second width smaller than a first width of a remainder of the waveguide core.

Illustrative clause 66. The THz interposer assembly of illustrative clause 63, wherein the pair of conductive traces comprises a first conductive trace and a second conductive trace forming a ground-signal (GS) configuration in the coupling region and extends from a transition region configured to transition between the GS configuration and a ground-signal-ground (GSG) configuration formed by the first conductive trace, the second conductive trace, and a third conductive trace.

Illustrative clause 67. The THz interposer assembly of illustrative clause 63, wherein the CPS coupling structure further comprises a dielectric layer disposed on an exterior surface of the THz interposer, wherein the pair of conductive traces are disposed on the dielectric layer.

Illustrative clause 68. The THz interposer assembly of illustrative clause 67, wherein the dielectric layer comprises benzocyclobutene (BCB).

Illustrative clause 69. The THz interposer assembly of illustrative clause 53, wherein the THz interposer further comprises a plurality of conductive walls, wherein each of the plurality of conductive walls is disposed between an adjacent pair of the plurality of THz waveguides and is one of continuous and non-continuous.

Illustrative clause 70. The THz interposer assembly of illustrative clause 69, wherein the THz interposer further comprises a first conductive layer disposed on a first external surface of the THz interposer and a second conductive layer disposed on a second external surface of the THz interposer opposite the first external surface, wherein each of the first conductive layer and the second conductive layer is one of continuous and non-continuous.

71. The THz interposer assembly of illustrative clause 70, wherein at least one of the plurality of conductive walls, the first conductive layer, and the second conductive layer comprises a metal.

Illustrative clause 72. The THz interposer assembly of illustrative clause 71, wherein the metal is selected from a group consisting of gold, silver, aluminum, and copper.

Illustrative clause 73. The THz interposer assembly of illustrative clause 53, wherein at least one of the plurality of THz waveguides has a waveguide core with a cross-section having a first dimension and a second dimension greater than the first dimension, wherein the respective one of the plurality of THz waveguides is configured to maintain a polarization of the one or more THz signals aligned with the second dimension.

Illustrative clause 74. The THz interposer assembly of illustrative clause 73, wherein the first dimension is in a range between 25 micrometers (μm) and 75 μm and the second dimension is in a range between 200 μm and 300 μm.

Illustrative clause 75. The THz interposer assembly of illustrative clause 53, further comprising a thermal pad disposed on an exterior surface of the THz interposer, wherein the thermal pad defines a plurality of openings, and each of the plurality of openings is aligned with a respective one of the plurality of first ports to permit passage of the one or more THz signals through the thermal pad.

Illustrative clause 76. The THz interposer assembly of illustrative clause 53, wherein at least one of the plurality of THz waveguides comprises a waveguide core and one or more waveguide sidewalls defining a waveguide channel, the waveguide core is disposed within the waveguide channel and spaced a distance from the one or more waveguide sidewalls to define a waveguide cladding region between the waveguide core and the one or more waveguide sidewalls, and the waveguide cladding region contains one of a gas, a dielectric, a semiconductor, and a vacuum.

Illustrative clause 77. The THz interposer assembly of illustrative clause 53, wherein at least one of the THz waveguides comprises one or more turns between the respective one of the plurality of first ports and the respective one of the plurality of second ports.

Illustrative clause 78. The THz interposer assembly of illustrative clause 77, wherein each of the one or more turns are in a range between 25 degrees and 155 degrees.

Illustrative clause 79. The THz interposer assembly of illustrative clause 53, wherein the THz interposer is a first THz interposer, the plurality of THz waveguides are a plurality of first THz waveguides, and the THz interposer assembly further comprises: a second THz interposer at least partially overlapping the first THz interposer and defining a plurality of third ports and a plurality of fourth ports; and a plurality of second THz waveguides disposed within the second THz interposer, wherein each of the plurality of second THz waveguides extends between a respective one of the plurality of third ports and a respective one of the plurality of fourth ports.

Illustrative clause 80. The THz interposer assembly of illustrative clause 79, wherein at least one of the plurality of second ports of the first THz interposer comprises a first evanescent coupling region defined by a first exterior surface of the first THz interposer, at least one of the plurality of third ports of the second THz interposer comprises a second evanescent coupling region defined by a second exterior surface of the second THz interposer facing the first exterior surface of the first THz interposer, the first THz interposer and the second THz interposer overlap such that the first evanescent coupling region at least partially overlaps the second evanescent coupling region to form an overlap region, and the overlap region is configured to evanescently couple the one or more THz signals between the first evanescent coupling region and the second evanescent coupling region.

Illustrative clause 81. The THz interposer assembly of illustrative clause 80, wherein the overlap region has a length extending along a longitudinal axis of the first exterior surface and the second exterior surface in a range between 200 micrometers (μm) and 440 μm.

Illustrative clause 82. The THz interposer assembly of illustrative clause 80, wherein at least one of the first evanescent coupling region and the second evanescent coupling region comprises a tapered region in which a waveguide core of the respective one of the plurality of THz waveguides narrows to a second width smaller than a first width of a remainder of the waveguide core.

Illustrative clause 83. The THz interposer assembly of illustrative clause 79, wherein at least one of the plurality of second ports comprises a first aperture defined by a first exterior surface of the first THz interposer, at least one of the plurality of third ports comprises a second aperture defined by a second exterior surface of the second THz interposer facing the first exterior surface of the first THz interposer, the first THz interposer and the second THz interposer overlap such that the first aperture and the second aperture are configured to couple the one or more THz signals between the first aperture and the second aperture.

Illustrative clause 84. The THz interposer assembly of illustrative clause 53, wherein at least one of the plurality of first ports has a first cross-sectional geometry, at least one of the plurality of second ports has a second cross-sectional geometry different from the first cross-sectional geometry, and at least one of the plurality of THz waveguides corresponding to the at least one of the plurality of first ports and the at least one of the plurality of second ports is configured to transition between the first cross-sectional geometry and the second cross-sectional geometry.

Illustrative clause 85. A Terahertz (THz) transmission system, comprising: one or more THz transceivers, each of one or more THz transceivers comprising one or more signal couplers; and

a THz interposer assembly, comprising: a THz interposer defining a plurality of first ports and a plurality of second ports; and a plurality of THz waveguides disposed within the THz interposer, wherein each of the plurality of THz waveguides extends between a respective one of the plurality of first ports and a respective one of the plurality of second ports, is configured to propagate, between the respective one of the plurality of first ports and the respective one of the plurality of second ports, one or more THz signals having a frequency in a range between 300 Gigahertz (GHz) and 10 THz with a propagation loss in a range between 0.001 decibels (dB) per centimeter (cm) and 1.0 dB per cm; wherein the THz interposer assembly is positioned such that at least one of the one or more signal couplers of the at least one of the one or more THz transceivers is coupled to at least one of the plurality of first ports.

Illustrative clause 86. The THz transmission system of illustrative clause 85, wherein the THz interposer assembly at least partially overlaps at least one of the one or more THz transceivers.

Illustrative clause 87. A method of using a Terahertz (THz) interposer assembly, comprising: generating, by a THz transmitter, one or more THz signals having a frequency in a range between 300 Gigahertz (GHz) and 10 THz; coupling the one or more THz signals into a first THz waveguide disposed within a THz interposer, the first THz waveguide being configured to propagate the one or more THz signals with a propagation loss in a range between 0.001 decibels (dB) per centimeter (cm) and 1.0 dB per cm; and coupling the one or more THz signals from the first THz waveguide into a signal structure disposed outside of the THz interposer.

Illustrative clause 88. A method of using a Terahertz (THz) interposer assembly, comprising: generating, by a first THz transmitter, one or more first THz signals having a frequency in a range between 300 Gigahertz (GHz) and 10 THz; generating, by a second THz transmitter, one or more second THz signals having a frequency in a range between 300 GHz and 10 THz; coupling the one or more first THz signals into a first THz waveguide disposed within a THz interposer, the first THz waveguide being configured to propagate the one or more first THz signals with a propagation loss in a range between 0.001 decibels (dB) per centimeter (cm) and 1 dB per cm; coupling the one or more second THz signals into a second THz waveguide disposed within the THz interposer, the second THz waveguide being configured to propagate the one or more second THz signals with a propagation loss in a range between 0.001 dB per cm and 1.0 dB per cm; coupling the one or more first THz signals from the first THz waveguide into a first signal structure disposed outside of the THz interposer; and coupling the one or more second THz signals from the second THz waveguide into a second signal structure disposed outside of the THz interposer.

Illustrative clause 89. A method of making a Terahertz (THz) interposer assembly, comprising: etching a plurality of base wafers to define a sidewall portion of a plurality of waveguide channels; etching a waveguide core wafer to define a plurality of waveguide cores and a plurality of support structures; and bonding the plurality of base wafers and the waveguide core wafer such that each of the plurality of waveguide cores are enclosed within the respective one of the plurality of waveguide channels to form a plurality of THz waveguides; wherein each of the plurality of THz waveguides extends between a respective one of a plurality of first ports and a respective one of a plurality of second ports and is configured to propagate, between the respective one of the plurality of first ports and the respective one of the plurality of second ports, one or more THz signals having a frequency in a range between 300 Gigahertz (GHz) and 10 THz with a propagation loss in a range between 0.001 decibels (dB) per centimeter (cm) and 1.0 dB per cm.

### CONCLUSION

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A Terahertz (THz) interposer assembly, comprising:
a THz interposer defining a plurality of first ports and a plurality of second ports; and
a plurality of THz waveguides disposed within the THz interposer, wherein each of the plurality of THz waveguides extends between a respective one of the plurality of first ports and a respective one of the plurality of second ports, and is configured to propagate, between the respective one of the plurality of first ports and the respective one of the plurality of second ports, one or more THz signals having a frequency in a range between 300 Gigahertz (GHz) and 10 THz with a propagation loss in a range between 0.001 decibels (dB) per centimeter (cm) and 1.0 dB per cm.

2. The THz interposer assembly of claim 1, wherein at least a portion of each of the plurality of THz waveguides comprises a dielectric material.

3. The THz interposer assembly of claim 2, wherein the dielectric material is selected from a group consisting of high-resistivity float zone silicon (HRFZ-Si), germanium (Ge), and diamond-like carbon (DLC).

4. The THz interposer assembly of claim 3, wherein the dielectric material is one of monocrystalline, polycrystalline, and amorphous.

5. The THz interposer assembly of claim 2, wherein the THz interposer comprises the dielectric material and has a plurality of interior surfaces defining the plurality of THz waveguides.

6. The THz interposer assembly of claim 2, wherein the THz interposer does not comprise the dielectric material, and the plurality of THz waveguides are embedded in the THz interposer.

7. The THz interposer assembly of claim 1, wherein at least one of the plurality of first ports comprises an aperture defined by an exterior surface of the THz interposer and configured to couple a respective one of the one or more THz signals between the respective one of the plurality of THz waveguides and a signal structure disposed adjacent to the aperture, wherein the signal structure is selected from a group consisting of an antenna, a coplanar stripline, a THz waveguide, and combinations thereof.

8. The THz interposer assembly of claim 1, wherein at least one of the plurality of first ports comprises an evanescent coupling region defined by an exterior surface of the THz interposer and configured to evanescently couple a respective one of the one or more THz signals between the respective one of the plurality of THz waveguides and a signal structure spaced a predetermined distance away from the respective one of the plurality of THz waveguides.

9. The THz interposer assembly of claim 8, wherein the predetermined distance is in a range between 2 micrometers (μm) and 45 μm.

10. The THz interposer assembly of claim 8, wherein the evanescent coupling region comprises a liftoff region in which the respective one of the plurality of THz waveguides is angled away from the exterior surface of the THz interposer to gradually increase a distance between the respective one of the plurality of THz waveguides and the signal structure.

11. The THz interposer assembly of claim 1, wherein at least one of the plurality of first ports comprises a coplanar stripline (CPS) coupling structure comprising a pair of conductive traces configured to carry a respective one of the one or more THz signals in a balanced mode and a coupling region in which the pair of conductive traces expands and a waveguide core of the respective one of the plurality of THz waveguides is disposed between the pair of conductive traces, wherein the coupling region is configured to couple an electric field of the one or more THz signals between the pair of conductive traces and the waveguide core.

12. The THz interposer assembly of claim 11, wherein the pair of conductive traces expands in the coupling region at an angle in a range between 6 degrees and 20 degrees relative to a longitudinal axis of the respective one of the plurality of THz waveguides.

13. The THz interposer assembly of claim 11, wherein the waveguide core comprises a tapered region disposed between the pair of conductive traces in which the waveguide core narrows to a second width smaller than a first width of a remainder of the waveguide core.

14. The THz interposer assembly of claim 11, wherein the pair of conductive traces comprises a first conductive trace and a second conductive trace forming a ground-signal (GS) configuration in the coupling region and extends from a transition region configured to transition between the GS configuration and a ground-signal-ground (GSG) configuration formed by the first conductive trace, the second conductive trace, and a third conductive trace.

15. The THz interposer assembly of claim 11, wherein the CPS coupling structure further comprises a dielectric layer disposed on an exterior surface of the THz interposer, wherein the pair of conductive traces are disposed on the dielectric layer.

16. The THz interposer assembly of claim 15, wherein the dielectric layer comprises benzocyclobutene (BCB).

17. The THz interposer assembly of claim 1, wherein the THz interposer further comprises a plurality of conductive walls, wherein each of the plurality of conductive walls is disposed between an adjacent pair of the plurality of THz waveguides and is one of continuous and non-continuous.

18. The THz interposer assembly of claim 17, wherein the THz interposer further comprises a first conductive layer disposed on a first external surface of the THz interposer and a second conductive layer disposed on a second external surface of the THz interposer opposite the first external surface, wherein each of the first conductive layer and the second conductive layer is one of continuous and non-continuous.

19. The THz interposer assembly of claim 18, wherein at least one of the plurality of conductive walls, the first conductive layer, and the second conductive layer comprises a metal.

20. The THz interposer assembly of claim 19, wherein the metal is selected from a group consisting of gold, silver, aluminum, and copper.

21. The THz interposer assembly of claim 1, wherein at least one of the plurality of THz waveguides has a waveguide core with a cross-section having a first dimension and a second dimension greater than the first dimension, wherein the respective one of the plurality of THz waveguides is configured to maintain a polarization of the one or more THz signals aligned with the second dimension.

22. The THz interposer assembly of claim 21, wherein the first dimension is in a range between 25 micrometers (μm) and 75 μm and the second dimension is in a range between 200 μm and 300 μm.

23. The THz interposer assembly of claim 1, further comprising a thermal pad disposed on an exterior surface of the THz interposer, wherein the thermal pad defines a plurality of openings, and each of the plurality of openings is aligned with a respective one of the plurality of first ports to permit passage of the one or more THz signals through the thermal pad.

24. The THz interposer assembly of claim 1, wherein at least one of the plurality of THz waveguides comprises a waveguide core and one or more waveguide sidewalls defining a waveguide channel, the waveguide core is disposed within the waveguide channel and spaced a distance from the one or more waveguide sidewalls to define a waveguide cladding region between the waveguide core and the one or more waveguide sidewalls, and the waveguide cladding region contains one of a gas, a dielectric, a semiconductor, and a vacuum.

25. The THz interposer assembly of claim 1, wherein at least one of the THz waveguides comprises one or more turns between the respective one of the plurality of first ports and the respective one of the plurality of second ports.

26. The THz interposer assembly of claim 25, wherein each of the one or more turns are in a range between 25 degrees and 155 degrees.

27. The THz interposer assembly of claim 1, wherein the THz interposer is a first THz interposer, the plurality of THz waveguides are a plurality of first THz waveguides, and the THz interposer assembly further comprises:
a second THz interposer at least partially overlapping the first THz interposer and defining a plurality of third ports and a plurality of fourth ports; and
a plurality of second THz waveguides disposed within the second THz interposer, wherein each of the plurality of second THz waveguides extends between a respective one of the plurality of third ports and a respective one of the plurality of fourth ports.

28. The THz interposer assembly of claim 27, wherein at least one of the plurality of second ports of the first THz interposer comprises a first evanescent coupling region defined by a first exterior surface of the first THz interposer, at least one of the plurality of third ports of the second THz interposer comprises a second evanescent coupling region defined by a second exterior surface of the second THz interposer facing the first exterior surface of the first THz interposer, the first THz interposer and the second THz interposer overlap such that the first evanescent coupling region at least partially overlaps the second evanescent coupling region to form an overlap region, and the overlap region is configured to evanescently couple the one or more THz signals between the first evanescent coupling region and the second evanescent coupling region.

29. The THz interposer assembly of claim 28, wherein the overlap region has a length extending along a longitudinal axis of the first exterior surface and the second exterior surface in a range between 200 micrometers (μm) and 440 μm.

30. The THz interposer assembly of claim 28, wherein at least one of the first evanescent coupling region and the second evanescent coupling region comprises a tapered region in which a waveguide core of the respective one of the plurality of THz waveguides narrows to a second width smaller than a first width of a remainder of the waveguide core.

31. The THz interposer assembly of claim 27, wherein at least one of the plurality of second ports comprises a first aperture defined by a first exterior surface of the first THz interposer, at least one of the plurality of third ports comprises a second aperture defined by a second exterior surface of the second THz interposer facing the first exterior surface of the first THz interposer, the first THz interposer and the second THz interposer overlap such that the first aperture and the second aperture are configured to couple the one or more THz signals between the first aperture and the second aperture.

32. The THz interposer assembly of claim 1, wherein at least one of the plurality of first ports has a first cross-sectional geometry, at least one of the plurality of second ports has a second cross-sectional geometry different from the first cross-sectional geometry, and at least one of the plurality of THz waveguides corresponding to the at least one of the plurality of first ports and the at least one of the plurality of second ports is configured to transition between the first cross-sectional geometry and the second cross-sectional geometry.

33. A Terahertz (THz) transmission system, comprising:
one or more THz transceivers, each of one or more THz transceivers comprising one or more signal couplers; and
a THz interposer assembly, comprising:
a THz interposer defining a plurality of first ports and a plurality of second ports; and
a plurality of THz waveguides disposed within the THz interposer, wherein each of the plurality of THz waveguides extends between a respective one of the plurality of first ports and a respective one of the plurality of second ports, is configured to propagate, between the respective one of the plurality of first ports and the respective one of the plurality of second ports, one or more THz signals having a frequency in a range between 300 Gigahertz (GHz) and 10 THz with a propagation loss in a range between 0.001 decibels (dB) per centimeter (cm) and 1.0 dB per cm;
wherein the THz interposer assembly is positioned such that at least one of the one or more signal couplers of the at least one of the one or more THz transceivers is coupled to at least one of the plurality of first ports.

34. The THz transmission system of claim 33, wherein the THz interposer assembly at least partially overlaps at least one of the one or more THz transceivers.

35. A method of using a Terahertz (THz) interposer assembly, comprising:
generating, by a THz transmitter, one or more THz signals having a frequency in a range between 300 Gigahertz (GHz) and 10 THz;
coupling the one or more THz signals into a first THz waveguide disposed within a THz interposer, the first THz waveguide being configured to propagate the one or more THz signals with a propagation loss in a range between 0.001 decibels (dB) per centimeter (cm) and 1.0 dB per cm; and
coupling the one or more THz signals from the first THz waveguide into a signal structure disposed outside of the THz interposer.

36. A method of using a Terahertz (THz) interposer assembly, comprising:
generating, by a first THz transmitter, one or more first THz signals having a frequency in a range between 300 Gigahertz (GHz) and 10 THz;
generating, by a second THz transmitter, one or more second THz signals having a frequency in a range between 300 GHz and 10 THz;
coupling the one or more first THz signals into a first THz waveguide disposed within a THz interposer, the first THz waveguide being configured to propagate the one or more first THz signals with a propagation loss in a range between 0.001 decibels (dB) per centimeter (cm) and 1 dB per cm;
coupling the one or more second THz signals into a second THz waveguide disposed within the THz interposer, the second THz waveguide being configured to propagate the one or more second THz signals with a propagation loss in a range between 0.001 dB per cm and 1.0 dB per cm;
coupling the one or more first THz signals from the first THz waveguide into a first signal structure disposed outside of the THz interposer; and
coupling the one or more second THz signals from the second THz waveguide into a second signal structure disposed outside of the THz interposer.

37. A method of making a Terahertz (THz) interposer assembly, comprising:
etching a plurality of base wafers to define a sidewall portion of a plurality of waveguide channels;
etching a waveguide core wafer to define a plurality of waveguide cores and a plurality of support structures; and
bonding the plurality of base wafers and the waveguide core wafer such that each of the plurality of waveguide cores are enclosed within the respective one of the plurality of waveguide channels to form a plurality of THz waveguides;
wherein each of the plurality of THz waveguides extends between a respective one of a plurality of first ports and a respective one of a plurality of second ports and is configured to propagate, between the respective one of the plurality of first ports and the respective one of the plurality of second ports, one or more THz signals having a frequency in a range between 300 Gigahertz (GHz) and 10 THz with a propagation loss in a range between 0.001 decibels (dB) per centimeter (cm) and 1.0 dB per cm.
